(19) United States
(12) Patent Application Publication
(10) Pub. No.: US 2014/0019149 A1
(43) Pub. Date: Jan. 16, 2014

(54) Scheduling a Patient for a Remote, Virtual Consultation

(71) Applicant: RICOH COMPANY, LTD., Tokyo (JP)

(72) Inventors: Haixia Yu, San Jose, CA (US); Vipin Namboodiri, Karnataka (IN); Taro Terashi, Cupertino, CA (US)

(73) Assignee: RICOH COMPANY, LTD., Tokyo (JP)

(21) Appl. No.: 13/665,855

(22) Filed: Oct. 31, 2012

Related U.S. Application Data
(60) Provisional application No. 61/672,262, filed on Jul. 16, 2012.

(51) Int. Cl. G06F 19/00

(52) U.S. Cl. CPC G06F 19/3425
USPC 705/2

(57) ABSTRACT

A system and method for scheduling a patient for remote, virtual consultation by a first available matching medical service provider are disclosed. In one embodiment, the system includes a classifier, a medical analyzer and a scheduler. The classifier associates a specialty with the first medical service provider (FMSP). The medical analyzer identifies a condition associated with the patient and identifies a specialty of medical service provider that can address the condition. The scheduler generates a list of patients waiting for medical consultation, receives an indication of availability of the FMSP, selects a patient from the list of patients based at least in part on whether the FMSP is associated with the specialty of medical service provider that can address the condition associated with the patient, checks for an available consultation device at a node associated with the patient, and assigns the FMSP for remote, virtual consultation with the patient.

### CROSS REFERENCE TO RELATED APPLICATIONS

This application claims priority under 35 USC §119(e) to U.S. Application No. 61/672,262, entitled “Scheduling a Patient for a Remote, Virtual Consultation” filed Jul. 16, 2012, the entirety of which is herein incorporated by reference.

### BACKGROUND OF THE INVENTION

1. Field of the Invention

The specification relates to scheduling a patient for a medical consultation. In particular, the specification relates to scheduling patients for remote, virtual consultation by a medical service provider.

2. Description of the Problem

Medical access is difficult to obtain for many people, for example, when they live in rural areas. A first problem is that doctors may not be available nearby. A second problem is that any available doctors may be general practitioners and lack the technology and/or expertise to properly diagnose specific problems. One solution to this problem is to send doctors and/or specialized doctors into rural the area; however, this is a poor use of resources because it is difficult to determine when a doctor is needed and/or what specialty is needed before the appointment.

Previous attempts to solve this problem have included telemedicine, which is when a patient communicates remotely with a doctor over the internet. Simply providing the patient with a remote doctor, however, fails to solve the problem of automatically matching the patient with the appropriate doctor in real time in order to maximize doctor utilization.

### SUMMARY OF THE INVENTION

The specification overcomes the deficiencies and limitations of the prior art at least in part by providing a system and method for scheduling a patient for remote, virtual consultation by a first available matching medical service provider. The system includes a node where the patient is located, a hub where the doctor is located, an authorization server for controlling access to a patient queuing module, an electronic medical records server for storing patient data and a web services server for storing the web services server.

In one embodiment, the system comprises a classifier, a medical analyzer and a scheduler. The classifier associates a specialty with the first medical service provider. The medical analyzer identifies a condition associated with the patient and identifies a medical service provider with a specialty that can address the condition. The medical analyzer determines the condition of the patient based on information received from medical devices at the node. In one embodiment, the medical analyzer determines the condition of the patient based on information received from medical devices at the node.

The scheduler (1) adds patients into a queue for medical consultation, (2) receives an indication of availability of the first medical service provider, (3) responsive to receiving the indication of availability of the first medical provider, selects a patient from the list of patients based at least in part on whether the first medical service provider is associated with the specialty of the medical service provider that can address the condition associated with the patient, (4) checks for an available consultation device at a node associated with the patient, and (5) responsive to the consultation device being available to the patient at the node, assigns the first medical service provider for remote, virtual consultation of the patient.

In one embodiment, patients may be added to the queue by one or more of a trained technician at the node, a general physician at the hub, a specialist for a second opinion, a store and forward server and an analytics server. In one embodiment, the patient is added to the queue by a trained technician at the node. For example, a patient arriving at a node is inspected by a trained technician/general practitioner who identifies the urgency and the specialty of medical service provider the patient must meet. The technician queues the patient. The technician may identify a specialty or a particular specialist. Alternatively, in one embodiment, the scheduler selects the specialist based on patient history if the technician chooses the option. The scheduler schedules the remote consultation.

In one embodiment, the patient is added to the queue by a store and forward server. For example, the patient's vitals are collected offline and submitted to the scheduler. In one embodiment, the scheduler only assigns the patient report/record to the specialist. There is no remote-consultation involved. In one embodiment, store and forward is accomplished in an offline mode and is valid for situations where a delay in diagnosis is acceptable such as in some dermatology or pathology cases. In one embodiment, the scheduler treats store and forward transmissions as lower priority than live consultations.

In one embodiment, the patient is added to the queue by an analytics server. For example, the patient arrives at the node, vitals are collected, reports from other devices such as from an ECG, ophthalmoscope, otoscope and the data is streamed to an analytics server that analyzes the vitals and identifies the urgency and ailment type. The analytics server in turn queues the patient for remote consultation. In one embodiment, the vitals and reports from other devices are collected from a patient at the patient's home. In one embodiment, the patient is added to the queue when a patient with a scheduled appointment arrives at the node.

In one embodiment, the list of patients is an ordered list, the order based at least in part on one or more of arrival time of the patients, ailment type, patient appointment time and urgency of medical attention. In one embodiment, the scheduler determines a time period the patient has been on the list of patients waiting for the medical consultation. In one embodiment, responsive to the time period exceeding a threshold, the scheduler applies a reservation to the consultation device at the node associated with the patient. The reservation sets the availability of the consultation device for the patient. In one embodiment, responsive to the time period exceeding a threshold, the scheduler applies a reservation to the first medical service provider, wherein the ailment associated with the patient matches the specialty associated with the first medical service provider.

In one embodiment, the scheduler assigns a general practitioner to the patient instead of a specialist based on factors, such as how long the patient has been waiting to see a medical service provider. In one such embodiment, the system further includes a storage device operable to store virtual consultation data, and the scheduler receives instructions from the first medical provider. The scheduler, responsive to the instructions from the first medical service provider, forwards a pointer to the virtual consultation data to a second medical service provider associated with a specialty that matches the patient's ailment.

In another embodiment, the system further includes a patient preference engine operable to determine one or more preferences of the patient. In one such embodiment, the scheduler performs one or more of the selection of the patient and the assignment of the first medical service provider for remote, virtual consultation of the patient based at least in part on the one or more preferences of the patient.

The features and advantages described herein are not all-inclusive and many additional features and advantages will be apparent in view of the figures and description. Moreover, it should be noted that the language used in the specification has been principally selected for readability and instructional purposes, and not to limit the scope of the subject matter disclosed herein.

### BRIEF DESCRIPTION OF THE DRAWINGS

The embodiments are illustrated by way of example, and not by way of limitation in the figures of the accompanying drawings in which like reference numerals are used to refer to similar elements.

FIG. 1 illustrates a system for scheduling a patient for remote, virtual consultation by a first available matching medical service provider according to one embodiment.

FIG. 2A is a block diagram illustrating a web services server according to one embodiment.

FIG. 2B is a block diagram illustrating a patient queuing module according to one embodiment.

FIG. 3 illustrates an example of a user interface according to one embodiment.

FIG. 4 is a workflow diagram illustrating a method for scheduling a patient for remote, virtual consultation by a first available matching medical service provider according to one embodiment.

FIG. 5 is a flow chart illustrating another method for scheduling a patient for remote, virtual consultation by a first available matching medical service provider according to one embodiment.

FIG. 6 is a flow chart illustrating yet another method for scheduling a patient for remote, virtual consultation by a first available matching medical service provider according to one embodiment.

FIG. 7 is a simulation illustrating scheduling a patient for remote, virtual consultation by a first available matching medical service provider according to one embodiment.

FIG. 8 is another simulation illustrating scheduling a patient for remote, virtual consultation by a first available matching medical service provider according to another embodiment.

FIG. 9 is still another simulation illustrating scheduling a patient for remote, virtual consultation by a first available matching medical service provider according to yet another embodiment.

FIG. 10 is yet another simulation illustrating scheduling a patient for remote, virtual consultation by a first available matching medical service provider according to one embodiment.

FIG. 11 is yet another simulation illustrating scheduling a patient for remote, virtual consultation by a first available matching medical service provider according to one embodiment.

FIG. 12 is an illustration of algorithm pseudo-code for scheduling a patient for remote, virtual consultation by a first available matching medical service provider according to one embodiment.

### DETAILED DESCRIPTION

A system and method for scheduling a patient for remote, virtual consultation by a first available matching medical service provider is described. In the following description, for purposes of explanation, numerous specific details are set forth in order to provide a thorough understanding of the embodiments. It will be apparent, however, to one skilled in the art that the embodiments can be practiced without these specific details. In other instances, structures and devices are shown in block diagram form in order to avoid obscuring the embodiments. For example, one embodiment is described below with reference to user interfaces and particular hardware. However, the present embodiments apply to any type of computing device that can receive data and commands, and any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including, for example, “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The embodiments can take the form of an entirely hardware embodiment, an entirely software embodiment or an embodiment containing both hardware and software elements. An exemplary embodiment is implemented in software, which includes but is not limited to firmware, resident software, microcode, etc.

Furthermore, the embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present embodiments are not described with reference to any particular programming language. It will be appreciated that a variety of programming languages may be used to implement the teachings of the embodiments as described herein.

### System Overview

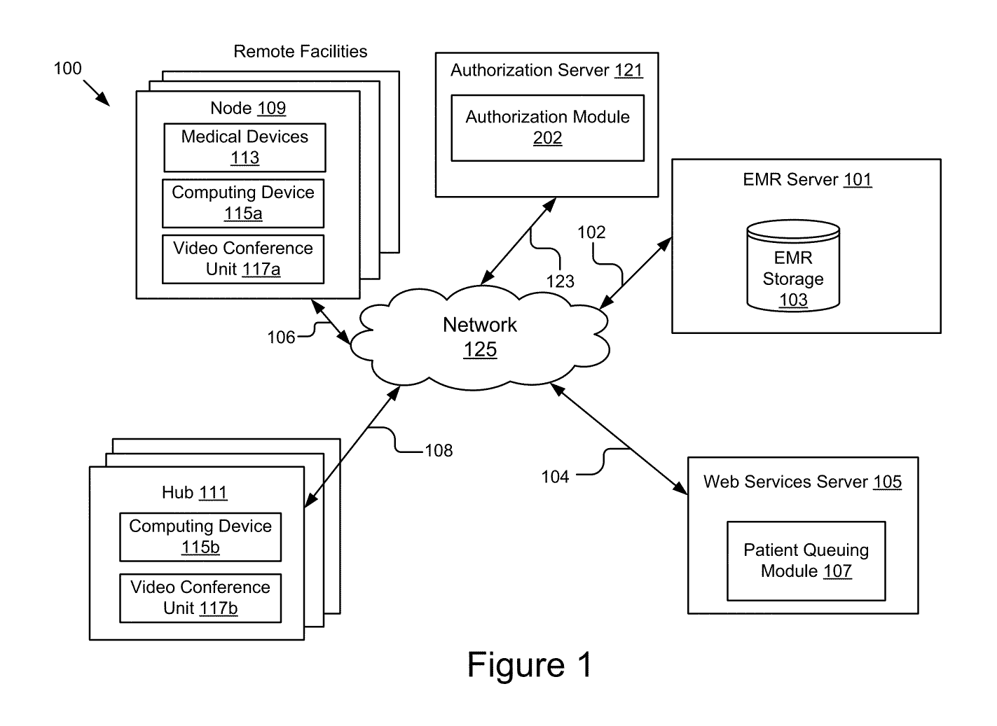

FIG. 1 illustrates a block diagram of a system 100 for scheduling a patient for remote, virtual consultation by a first available matching medical service provider according to one embodiment. The illustrated system 100 includes one or more nodes 109 (referred to collectively as nodes 109 or individually as node 109), an authorization server 121, an electronic medical record (EMR) server 101, one or more hubs 111 (referred to collectively as hubs 111 or individually as hub 111) and a web services server 105. In the illustrated embodiment, these entities are communicatively coupled via a network 125.

The nodes 109 in FIG. 1 are used by way of example. While FIG. 1 illustrates three nodes 109, the present specification applies to any system architecture having one or more nodes 109. Similarly, the hubs 111 in FIG. 1 are used by way of example. While FIG. 1 illustrates three hubs 111, the present specification applies to any system architecture having one or more hubs 111. Additionally, while only one network 125 is coupled to the nodes 109, the hubs 111, the EMR server 101 and the web services server 105, in practice any number of networks 125 can be connected to the entities. Furthermore, although only one EMR server 101 is shown, it will be recognized that multiple EMR servers 101 may be present. Moreover, although only one web services server 105 is shown, it will be recognized that multiple web services servers 105 may be present.

In one embodiment, the authorization server 121 comprises an authorization module 202 and is connected to the network 125 via signal line 123. The authorization module 202 is code and routines for registering a user generating a token for a user. In one embodiment, the authorization module 202 is a set of instructions executable by a processor. In another embodiment, the authorization module 202 is stored in memory and is accessible and executable by the processor.

The authorization module 202 servers as a gatekeeper for managing user access to the EMR server 101 and the web services server 105. In one embodiment, the authorization module 202 registers users including one or more of a medical service provider, node personnel and a patient. In one embodiment, the authorization module 202 registers medical service providers. In one embodiment, registering a medical service provider includes medical service provider login. For example, in one embodiment, the authorization module 202 registers a medical service provider when the authorization module 202 receives, from the hub 111, a login request associated with a medical service provider and determines to allow the login. In one embodiment, registering a medical service provider includes maintaining a medical service provider account. For example, in one embodiment, the authorization module 202 manages medical service provider accounts by creating medical service provider accounts (e.g. when new medical service providers are added to the system 100) and by updating existing medical service provider accounts. In one embodiment, a medical service provider account includes information regarding one or more of the associated medical service provider's education, experience and medical specialty.

In one embodiment, the authorization module 202 registers node personnel. In one embodiment, registering node personnel includes node personnel login. For example, in one embodiment, the authorization module 202 registers a technician when the authorization module 202 receives, from the node 109, a login request associated with the technician and determines to allow the login. In one embodiment, registering node personnel includes maintaining a node personnel account. For example, in one embodiment, the authorization module 202 manages node personnel accounts by creating node personnel accounts (e.g. when new node personnel are added to the system 100) and by updating existing node personnel accounts.

In one embodiment, the authorization module 202 registers patients. In one embodiment, registering a patient includes patient check-in. For example, assume a patient has arrived at the node 109 seeking a medical consultation, in one embodiment, the authorization module 202 registers the patient by passing a patient check-in signal to the patient queuing module 107 and the patient queuing module 107 adds the patient to a list of patients seeking medical consultation. In one embodiment, registering a patient includes patient intake. For example, assume a patient has arrived at the node 109 seeking a medical consultation, in one embodiment, the authorization module 202 registers the patient by requesting to update the patient's EMR in the EMR storage 103 or (if the patient is new) requesting to create a new EMR in the EMR storage 103. It will be recognized that the preceding are merely examples of registering patients and that other examples exist.

In one embodiment, the authorization module 202 registers users and issues a token to each user. For example, a nurse at the node 109 provides registration information, including for example a login/password or an authorized certificate, and the authorization module 202 issues a token for the nurse. In some embodiments, the EMR server 101 generates the token and the authorization module 202 uses the token to verify the identity of the user before providing the user with access to the web services server 105. The authentication process can be implemented as a sign-on process (e.g. a process that supports ID as a service) or over HTTPs.

The token is used to identify a user's identity. In one embodiment, the token has a predetermined time-to-live. For example, the token expires after one month and the authorization module 202 issues a new token to the user. In some embodiments, the token is also self-authenticable (e.g., the token is authenticable without proof).

In one embodiment, the authorization module 202 issues two tokens for each user: an identity token and an access token. The authorization module 202 receives the identity token that identifies a user's identity and determines whether to generate an authorization token for the user to access the web services server 105. For example, the authorization module 202 generates an authorization token for a technician at the node 109 who submits a patient for medical consultation and presents the authorization token to the scheduler 209 to assign a medical service provider at the hub 111 to consult with the patient. In one embodiment, the authorization module 202 receives an identity token from a user, generates an authorization token for the authenticated user and responds to the user with a message bundled with the authorization token.

FIG. 1 illustrates the authorization module 202 as being part of a sign-on server (the authentication server 121). In another embodiment, the authorization module 202 and its functionality are distributed across the system 100 (e.g. across the node 109, the hub 111, the EMR server 101 and the web services server 105). Distributing functionality in different servers is helpful in load balancing. In another embodiment, the authorization module 202 and its authorization functionality are included in the web services server 105.

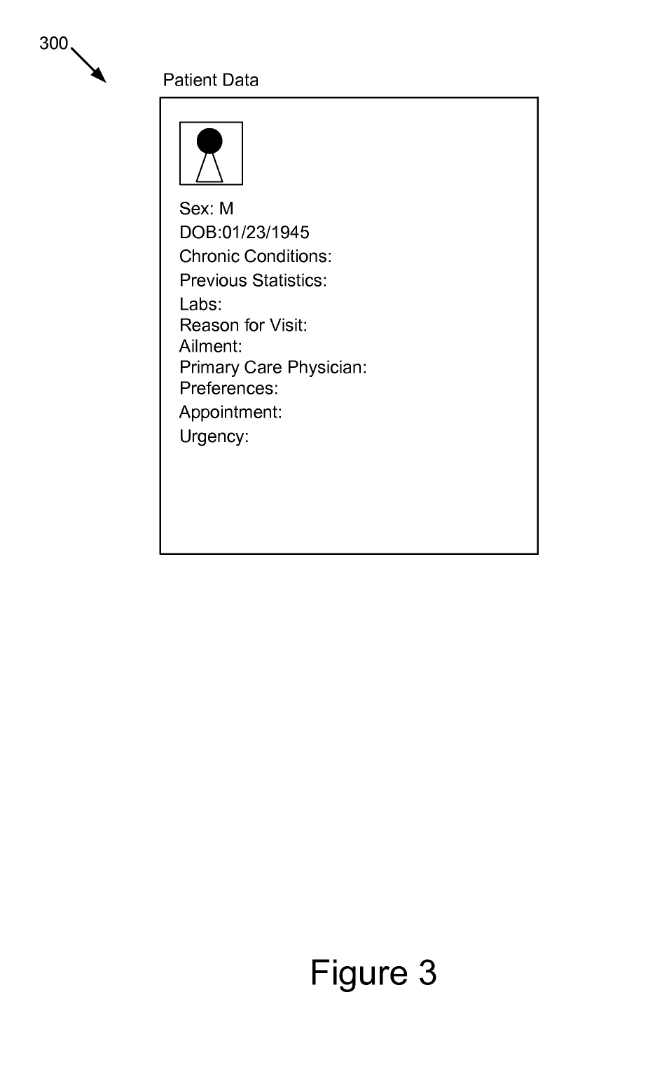

In one embodiment, a patient queuing module 107 is included in the web services server 105 and is operable on the web services server 105, which is connected to the network 125 via signal line 104. In one embodiment, the patient queuing module 107 includes multiple, distributed modules that cooperate with each other to perform the functions described below. Details describing the functionality and components of the patient queuing module 107 are explained in further detail below with regard to FIG. 3.

The network 125 enables communications between the nodes 109, the EMR server 101, the hubs 111 and the web services server 105. Thus, the network 125 can include links using technologies including, for example, Wi-Fi, Wi-Max, 2G, Universal Mobile Telecommunications System (UMTS), 3G, Ethernet, 802.11, integrated services digital network (ISDN), digital subscriber line (DSL), asynchronous transfer mode (ATM), InfiniBand, PCI Express Advanced Switching, etc. Similarly, the networking protocols used on the network 125 can include the transmission control protocol/Internet protocol (TCP/IP), multi-protocol label switching (MPLS), the User Datagram Protocol (UDP), the hypertext transport protocol (HTTP), the simple mail transfer protocol (SMTP), the file transfer protocol (FTP), lightweight directory access protocol (LDAP), Code Division Multiple Access (CDMA), Wideband Code Division Multiple Access (WCDMA), Global System for Mobile communications (GSM), High-Speed Downlink Packet Access (HSDPA), etc. The data exchanged over the network 125 can be represented using technologies and/or formats including the hypertext markup language (HTML), the extensible markup language (XML), etc. In addition, all or some of links can be encrypted using conventional encryption technologies, for example, the secure sockets layer (SSL), Secure HTTP and/or virtual private networks (VPNs) or Internet Protocol security (IPsec). In another embodiment, the entities can use custom and/or dedicated data communications technologies instead of, or in addition to, the ones described above. Depending upon the embodiment, the network 125 can also include links to other networks.

In one embodiment, the network 125 is a partially public or a wholly public network, for example, the Internet. The network 125 can also be a private network or include one or more distinct or logical private networks (e.g., virtual private networks, Wide Area Networks (“WAN”) and/or Local Area Networks (“LAN”)). Additionally, the communication links to and from the network 125 can be wireline or wireless (i.e., terrestrial or satellite-based transceivers). In one embodiment, the network 125 is an IP-based wide or metropolitan area network.

In the illustrated embodiment, the nodes 109 are communicatively coupled to the network 125 as illustrated by signal line 106. The hubs 111 are communicatively coupled to the network 125 as illustrated by signal line 108. The EMR server 101 is communicatively coupled to the network 125 via signal line 102. The web services server is communicatively coupled to the network via signal line 104. In one embodiment, the system 100 includes one or more of an analytics server (not shown) and a store and forward server (not shown) that are each communicatively coupled to the network 125 by a signal line (not shown).

In one embodiment, EMR server 101 includes EMR storage 103. In one embodiment, the EMR storage 103 is a database that includes electronic medical records for all patients of the system 100. In one embodiment, each time a node 109 or hub 111 transmits information about a patient, the EMR storage 103 updates that patient's electronic medical record.

In one embodiment, the node 109 is where patients receive a medical consultation and includes a computing device 115a and medical devices 113. In one embodiment, the node 109 is located remotely from the hubs 111. For example, the node 109 is a facility physically located in a rural area and a hub 111 is physically located in a city or other metropolitan area. In another example, the node 109 is a patient's home and the hub 111 is a nearby hospital. It will be recognized that the preceding are merely examples of a node 109 located remotely from a hub and that other examples exist. In one embodiment, the node 109 is mobile. For example, the node 109 is a vehicle with a computing device 115a and medical devices 113, which travels to various locations and patients receive medical consultation at the vehicle.

In one embodiment, the medical devices 113 include one or more of a general medical device and a specific medical device. Examples of general medical devices 113 include, but are not limited to, a stethoscope, a blood pressure meter, a pulse oximeter, a thermometer, an ophthalmoscope, a weight and height scale, an otoscope, a camera, etc. It will be recognized that the preceding are merely examples of general medical devices and that other examples exist. Examples of specific medical devices include, but are not limited to, a telecardiology device (e.g. an ECG machine), a telepathology device (e.g. a microscope), a teledermatology device (e.g. a high-resolution camera), a teleradiology device (e.g. an ultrasound machine), etc.

In one embodiment, one or more of the medical devices 113 are integrated. In one embodiment, an integrated medical device is communicatively coupled to the node 109 to enable store and forward functionality. For example, in one embodiment, an integrated medical device 113 is communicatively coupled to the node's computing device 115a to automatically send its output to the computing device 115a. The integrated medical device output is captured by software on the node's computing device 115a and automatically forwarded to the EMR server 101 according to one embodiment. Such an embodiment may beneficially reduce errors from node personnel misreading the medical device 113 and transcription errors from node personnel miss-recording the output of the medical device 113.

Store and forward is an asynchronous, non-interactive form of telemedicine. In one embodiment, store and forward is applied when the patient and doctor are not available at the same time. For example, in one embodiment, patient data is collected or acquired by the node 109 and stored on a computing device 115a at the node 109, and then forwarded to a hub doctor via the network 125. The hub doctor, at a later time, reviews the information and responds with a diagnosis, recommendations, requests for additional information etc.

In some embodiments, the node 109 uses store and forward when there is no direct connectivity between the node 109 and the hub 111. The node 109 stores a local copy of the patient data and synchronizes with the hub 111 whenever the node 109 is connected to the Internet. This is particularly helpful in this situation because the node 109 can often experience poor network connections. For example, when a technician is out in a remote region helping patients, the technician can gather the patient data, wait until the node 109 has a better connection, sync up the data to the EMR server 101 and a notification will be sent to the appropriate doctor to view the case and perform a diagnosis. After receiving the diagnosis from the doctor, the technician can give out prescribed medicine or perform and additional lab-work request for the patient.

The node 109 is staffed by personnel to operate the computing device 115a and medical devices 113. For example, the personnel includes a nurse trained to use the medical devices 113 to obtain the patient's medical information and to use the computing device 115a to register the patient for medical consultation. In one embodiment, the personnel at the node 109 is not as highly educated and/or is less specialized than the medical service provider at the hub 111. For example, assume the node is staffed by one or more of a nurse, medical technician, lab technician, physician's assistant and the medical service provider is a doctor (e.g. a general practitioner or a specialist).

Staffing the node 109 with personnel that are not medical service providers may beneficially increase the effectiveness of each medical service provider in the system 100. For example, where there is a shortage of doctors in the region, each remote node 109 includes a medical technician, who may be trained more quickly than a doctor. In one embodiment, the medical technician registers the patient, takes the patient's vital signs and uses additional medical devices 113 based on the complaint. The doctor receives the medical information of the patient, which was gathered in part by the medical technician, and consults with the patient. For example, if the patient is complaining about a rash, the technician may use the high-resolution camera to take a picture of the problematic area, which the doctor may view and discuss with the patient. The doctor's effectiveness is therefore increased by allowing the medical service provider to spend more time consulting with and diagnosing patients and less time traveling to the various, remote locations of patients and performing less specialized tasks such as patient registration, gathering basic vital signs, etc.

The node 109 includes at least one computing device 115a. In one embodiment, the computing device 115a is used by a patient at the node to access a medical service provider at the hub 111 for medical consultation. For example, the computing device 115a is a laptop computer, a desktop computer, a tablet computer, a mobile telephone, a personal digital assistant (PDA), a mobile email device, a television with one or more processors embedded therein or coupled thereto or any other electronic device capable of accessing the network 125.

In one embodiment, the node 109 includes a video conference unit 117a. In one embodiment, the video conference unit 117a is a hardware based solution. In another embodiment, the video conference unit 117a is a software based solution. In one embodiment, the video conference unit 117a is a computing device 115a including a web camera or other device for capturing video of the patient and video conferencing software. Regardless of the embodiment, the video of the patient is transmitted to the hub 111 after the patient is assigned a medical service provider. The video conference unit 117a used by a patient at the node 109 to access a medical service provider at the hub 111 for medical consultation is occasionally referred to herein as a “consultation device.”

In one embodiment, a hub 111 is a centralized physical facility that connects with the nodes 109 and allows a medical service provider to remotely consult with and diagnose patients at a node 109 on an as needed basis using an information technology infrastructure (not shown). The hub 111's information technology infrastructure includes, for example, a computing device 115b, a video conference unit 117b, a digital clipboard, a monitor, a collaboration display and a printer.

The hub 111 includes at least one computing device 115b. In one embodiment, the computing device 115b is used by the medical service provider at the hub 111 to access patient information and consult with a patient at the node 109. For example, the computing device 115b is a laptop computer, a desktop computer, a tablet computer, a mobile telephone, a personal digital assistant (PDA), a mobile email device, a television with one or more processors embedded therein or coupled thereto or any other electronic device capable of accessing the network 125. The hub 111 includes software, for example, that allows doctors to log into the system, search for patients, schedule patients, order prescriptions, make notes, perform video conferencing, generate reports and perform analytics. For example, the computing device 115b includes software that allows doctors to log into the system, search for patients, schedule patients, order prescriptions, make notes, perform video conferencing, generate reports and perform analytics.

In one embodiment, the hub 111 includes a video conference unit 117b. In one embodiment, the video conference unit 117b is a hardware based solution. In another embodiment, the video conference device 117b is a software based solution. In one embodiment, the video conference unit is a computing device 115b including a web camera or other device for capturing video of the medical service provider and video conferencing software. Regardless of the embodiment, the video of the medical service provider is transmitted to the node 109 when the medical service provider is consulting with a patient at the node 109.

By allowing remote consultation of a patient at a node by a medical service provider at a hub, the medical service provider is more effectively used and patients may receive higher quality medical care. For example, assume the medical service provider is a cardiologist in a major city where the hub 111 is located. Also assume that a patient located in a rural location far from the city is having heart related problems. In one embodiment, the hub allows the cardiologist to remotely consult with and diagnose the rurally located patient without traveling to the patient's location. Therefore, the cardiologist may use the time the cardiologist would have spent traveling to the patient to consult with and diagnose additional patients thereby increasing the utilization of the cardiologist. Moreover, the rural patient is allowed to consult with and be diagnosed by a specialist (i.e. a cardiologist who specializes in the cardiac system, which includes the heart), which may not have otherwise been an option for the patient thereby increasing the quality of medical care the patient receives. It will be recognized that the preceding is merely an example of how remote consultation of a patient at a node 109 by a medical service provider at a hub 111 may increase usage of a medical service provider and increase the quality of medical care a patient receives.

### Web Services Server 105

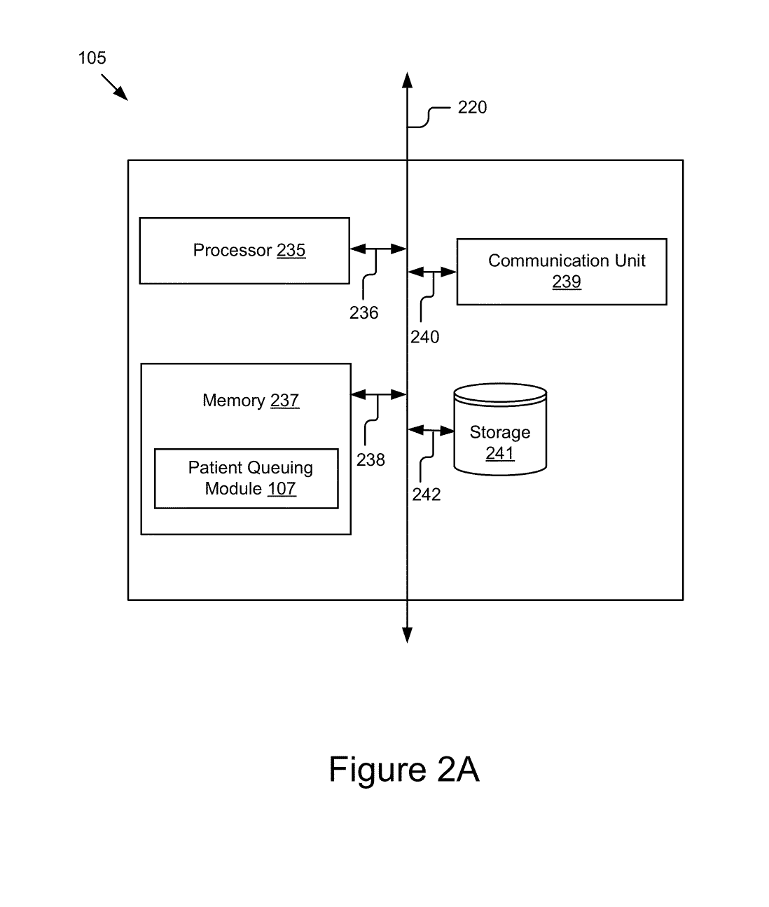

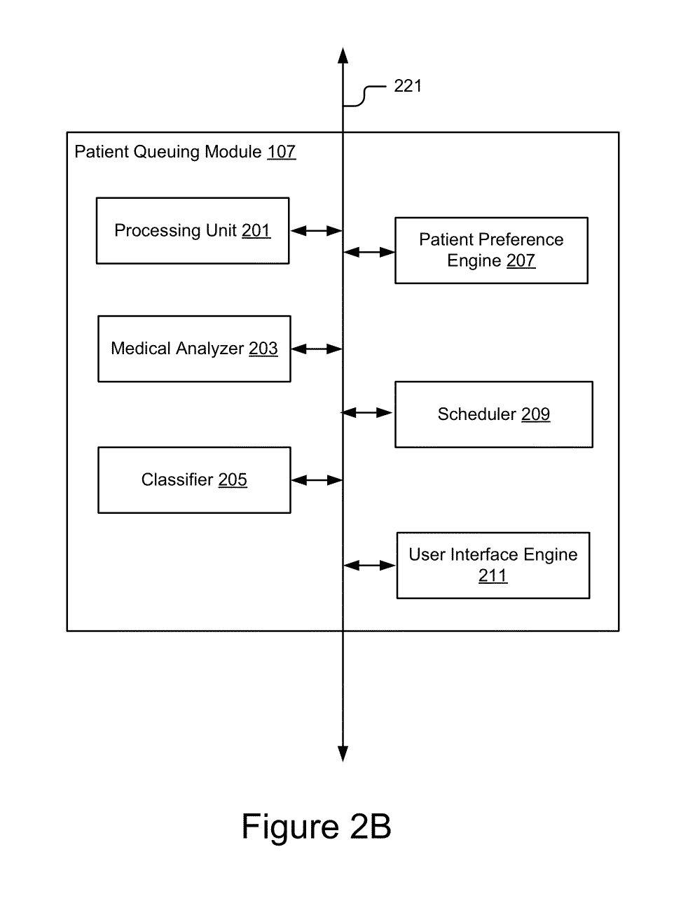

FIG. 2A is a block diagram of a web services server 105 according to one embodiment. As illustrated in FIG. 2A, the web services server 105 includes a processor 235, a memory 237, communications unit 239 and storage 241 coupled to a bus 220. In one embodiment, the functionality of the bus 220 is provided by an interconnecting chipset.

The communication unit 239 receives data from the nodes 109, the hubs 111 and the EMR server 101. The communication unit 239 sends the data to the patent queuing module 107. The communication unit 239 is coupled to the bus 220 via signal line 240. In one embodiment, the communication unit 239 includes a port for direct physical connection to the network 125 or to another communication channel. For example, the communication unit 239 includes a USB, SD, CAT-5 or similar port for wired communication with the network 125. In another embodiment, the communication unit 239 includes a wireless transceiver for exchanging data with the network 113, or with another communication channel, using one or more wireless communication methods, such as IEEE 802.11, IEEE 802.16, BLUETOOTH®, near field communication (NFC) or another suitable wireless communication method. In one embodiment, the communication unit 239 includes a NFC chip that generates a radio frequency (RF) for short-range communication.

The processor 235 may be any general-purpose processor. The processor 235 comprises an arithmetic logic unit, a microprocessor, a general purpose controller or some other processor array to perform computations and execute code and routines. The processor 235 is coupled to the bus 220 for communication with the other components of the web services server 105. Processor 235 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2A, multiple processors may be included. The processing capability may be limited to supporting the display of images and the capture and transmission of images. The processing capability might be enough to perform more complex tasks, including various types of feature extraction and sampling. The web services server 105 also includes an operating system executable by the processor including but not limited to WINDOWS®, MacOS X, Android or UNIX® based operating systems. It will be obvious to one skilled in the art that other processors, operating systems, sensors, displays and physical configurations are possible.

The memory 237 is a non-transitory storage medium. The memory 237 holds instructions and/or data that may be executed by the processor 235. In one embodiment, the instructions and/or data stored on the memory 237 comprise code for performing any and/or all of the techniques described herein. The memory 237 may be a dynamic random access memory (DRAM) device, a static random access memory (SRAM) device, flash memory or some other memory device known in the art. In one embodiment, the memory 237 also includes a non-volatile memory or similar permanent storage device and media, for example, a hard disk drive, a floppy disk drive, a CD-ROM device, a DVD-ROM device, a DVD-RAM device, a DVD-RW device, a flash memory device, or some other mass storage device known in the art for storing information on a more permanent basis. The memory 237 is coupled by the bus 220 for communication with the other components of the web services server 105. In one embodiment, the patient queuing module 107 is stored in memory 237 and executable by the processor 235.

The patient queuing module 107 is code and routines executable by the processor 235 for scheduling patients for remote, virtual consultation by a medical service provider. In one embodiment, the patient queuing module 107 is a set of instructions executable by the processor 235. In another embodiment, the patient queuing module 107 is stored in the memory 237 and is accessible and executable by the processor 235. Details describing the functionality and components of the patient queuing module 107 are explained in further detail below in reference to FIG. 2B.

The storage device 241 is any device capable of holding data, like a hard drive, compact disk read-only memory (CD-ROM), DVD, or a solid-state memory device. The storage device 241 is a non-volatile memory device or similar permanent storage device and media. The storage device 241 stores data and instructions for processor 208 and comprises one or more devices including a hard disk drive, a floppy disk drive, a CD-ROM device, a DVD-ROM device, a DVD-RAM device, a DVD-RW device, a flash memory device, or some other mass storage device known in the art. In one embodiment, the storage device 241 stores data and information of the web services server 105. For example, data and information generated by the patient queuing module 107 and its components.

As is known in the art, a web services server 105 can have different and/or other components than those shown in FIG. 2A. Moreover, the storage device 241 can be local and/or remote from the web services server 105 (e.g., a storage area network (SAN)).

As is known in the art, the web services server 105 is adapted to execute computer program modules for providing the functionality described herein. As used herein, the term “module” refers to computer program logic utilized to provide the specified functionality. Thus, a module can be implemented in hardware, firmware, and/or software. In one embodiment, program modules are stored on the storage device 241, loaded into the memory 237 and executed by the processor 235.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

### Patient Queuing Module 107

Referring now to FIG. 2B, the patient queuing module 107 is shown in more detail according to one embodiment. FIG. 2B is a block diagram of the patient queuing module 107 included in a web services server 105.

In one embodiment, the patient queuing module 107 includes a processing unit 201, a medical analyzer 203, a classifier 205, an optional patient preference engine 207, a scheduler 209 and a user interface engine 211.

It will be recognized that the modules 201, 203, 205, 207, 209, 211 comprising the patient queuing module 107 are not necessarily all on the same web services server 105. In one embodiment, the modules 201, 203, 205, 207, 209, 211 are distributed across the system 100. For example, in one embodiment, the processing unit 201 is included in a computing device 115a at the node 109 or hub 111 and the other modules 203, 205, 207, 209, 211 are included in the web services server 105. In another example, the system may include a second web services server 105 (not shown) and the modules 201, 203, 205, 207, 209, 211 are divided between the two web services servers 105. In yet another example, in one embodiment, the medical analyzer 203 is included in an analytics server (not shown).

The processing unit 201 is code and routines for obtaining information from one or more of the node 109, the hub 111 and the EMR server 101 and transmitting the information to the appropriate component of the system 100. In one embodiment, the processing unit 201 is a set of instructions executable by the processor 235. In another embodiment, the processing unit 201 is stored in the memory 237 and is accessible and executable by the processor 235. In either embodiment, the processing unit 201 is adapted for cooperation and communication with the processor 235, other components of the web services server 105 and other components of the patient queuing module 107.

The processing unit 201 obtains information from one or more of the node 109, the hub 111 and the EMR server 101 and transmits the information to the appropriate component of the system 100. For example, in one embodiment, the processing unit 201 is communicatively coupled to the node 109 and the EMR server 101 to pass patient medical information from the node 109 to the EMR server 101 for storage in the EMR storage 103. In another example, in one embodiment, the processing unit 201 is communicatively coupled to the node 109 and the EMR server 101 to obtain patient medical information from one or more of the node 109 and the EMR server 101 to the medical analyzer 203. In yet another example, in one embodiment, the processing unit 201 is communicatively coupled to the classifier 205 and the scheduler 209 to pass the output of the classifier 205 (e.g., a specialty associated with a first medical service provider) to the scheduler 209.

This description may occasionally omit mention of the processing unit 201 for purposes of clarity and convenience. For example, for purposes of clarity and convenience, the above scenarios may be described as the node 109 passing patient medical information to the EMR server 101 for storage in the EMR storage 103, passing patient medical information from one or more of the node 109 and the EMR server 101 to the medical analyzer 203 and passing the specialty associated with a first medical service provider to the scheduler 209, respectively.

In one embodiment, the processing unit 201 receives a message from the authorization module 202 indicating that a user at the node 109 or the hub 111 (e.g., a patient, a node personnel or a medical service provider) has been successfully registered and the token was authenticated.

In one embodiment, the processing unit 201 passes information to the appropriate component of the system 100. For example, the processing unit 201 is communicatively coupled to one or more of the components of the system to send the information to the appropriate component of the system 100. In another embodiment, the processing unit 201 stores the information in the storage device 241 (or any other non-transitory storage medium communicatively accessible). The appropriate component of the system 100 can retrieve the information by accessing the storage device 241 (or other non-transitory storage medium).

The medical analyzer 203 is code and routines for associating a patient with an ailment that determines the specialty of a medical service provider that can address the patient's condition. In one embodiment, the medical analyzer 203 is a set of instructions executable by the processor 235. In another embodiment, the medical analyzer 203 is stored in the memory 237 and is accessible and executable by the processor 235. In either embodiment, the medical analyzer 203 is adapted for cooperation and communication with the processor 235, other components of the web services server 105 and other components of the patient queuing module 107.

In one embodiment, the patient is associated with an ailment that determines the specialty of medical service provider that can address the patient's condition based on input of one or more of the node personnel and a medical service provider. For example, assume a nurse at the node 109 inputs, using the computing device 115a, that the patient may be seen by either a dermatologist or a general practitioner since the patient is seeking consultation regarding a rash, in one embodiment, the medical analyzer 203 associates dermatology and general medicine with the patient. In another example, assuming a general practitioner (i.e. a medical service provider) sees the rash and indicates the rash is unusual, in one embodiment, the medical analyzer 203 associates dermatology with the patient.

In one embodiment, the patient is associated with an ailment that determines the specialty of a medical service provider that can address the patient's condition based on analysis performed by the medical analyzer 203. For example, in one embodiment, the medical analyzer 203 receives patient medical information, analyzes the patient medical information and associates the patient's ailment with a specialty based on the analysis of the patient medical information.

In one embodiment, the medical analyzer 203 receives patient medical information. Examples of patient medical information include, but are not limited to, one or more of lab results, test results, medical device 113 outputs (e.g. vital signs), medical history, symptoms, etc.

In one embodiment, the medical analyzer 203 receives patient medical information from a node 109. For example, assume a test kit was used on the patient at the node 109, in one embodiment, the medical analyzer 203 receives the results of the test kit. In another example, assume the patient's medical symptoms are obtained by the node personnel and entered into the computing device 115a, in one embodiment, the medical analyzer 203 receives the symptoms from the computing device 115a of the node 109. In yet another example, assume a medical device 113 is used on the patient at the node 109, in one embodiment, the medical analyzer 203 receives output of the medical device 113. In one such embodiment, the medical analyzer 203 automatically receives patient medical information from an integrated medical device 113 without requiring recording or data entry of the output by the node personnel.

In one embodiment, the medical analyzer 203 receives patient medical information from the EMR server 101. For example, the medical analyzer 203 receives the patient's medical history as part of the patient's EMR. In one embodiment, the medical analyzer 203 automatically queries the EMR server 101 for relevant prior medical information in response to receiving an indication of a condition. This can help aid in diagnosis in conjunction with other information. For example, the medical analyzer 203 receives an indication that the patient might have melanoma and, in response, the medical analyzer 203 queries the EMR server 101 for previous images of the patient's back so that the medical analyzer 203 can compare the size (or absence) of moles in the past to the current size to identify fast-growing moles.

In one embodiment, the medical analyzer 203 analyzes the received patient information and associates the patient with a specialty based on the analysis of the patient's medical information, such as the patient's ailment. For example, assume the patient information received includes that the patient's symptoms are tingling in his/her feet and a headache and the patient's EMR includes medical history showing that the patient is diabetic. In one embodiment, the medical analyzer 203 identifies that the patient's condition is most likely hyperglycemia based on the symptoms and medical history, which is a condition that may be addressed by a general practitioner, so general medicine is associated with the patient.

In one embodiment, the medical analyzer 203 passes the ailment associated with the patient to the scheduler 209. For example, the medical analyzer 203 is communicatively coupled to the scheduler 209 to send the ailment associated with the patient to the scheduler 209. In another embodiment, the medical analyzer 203 stores the ailment associated with the patient in the storage device 241 (or any other non-transitory storage medium communicatively accessible). The other modules of the patient queuing module 107 including the scheduler 209 can retrieve the ailment associated with the patient by accessing the storage device 241 (or other non-transitory storage medium). In yet another embodiment, the medical analyzer 203 passes the ailment associated with the patient to the EMR server 101 to update the patient's EMR in the EMR storage 103 and the other components of the patient queuing module 107 including the scheduler 209 can obtain the ailment associated with the patient from the EMR storage 103. For example, the medical analyzer 203 is communicatively coupled to the EMR server 101 to send the ailment associated with the patient for storage in the EMR storage 103 and, in one embodiment, the scheduler 209 is communicatively coupled to obtain the one or more ailments therefrom.

The classifier 205 is code and routines for associating a classification with a user. In one embodiment, the classifier 205 is a set of instructions executable by the processor 235. In another embodiment, the classifier 205 is stored in the memory 237 and is accessible and executable by the processor 235. In either embodiment, the classifier 205 is adapted for cooperation and communication with the processor 235, other components of the web services server 105 and other components of the patient queuing module 107.

In one embodiment, the user is a medical service provider. In one such embodiment, the classification includes the medical service provider's specialty. In one embodiment, the medical service provider's specialty is based at least in part on one or more of the medical service provider's education and experience. For example, assume the medical service provider is board certified in the field of dermatology, in one embodiment, the classifier 205 associates the specialty of dermatology with the medical service provider.

In one embodiment, the user is a patient. A classification may be associated with a patient based on one or more of the urgency of the patient's need for medical attention, whether the patient has an appointment, expected duration of a consultation for the patient, the patient's medical insurance carrier, the patient's primary care physician, etc.

In one embodiment, the classifier 205 associates the patient with a classification based on the urgency of the patient's need to consult a medical service provider. For example, in one embodiment, the classifier 205 associates a patient with a suspicious lump with an urgent classification. Depending on the embodiment, the classification may be determined by node personnel or automatically determined by the medical analyzer 203. If the patient is experiencing a true emergency situation, such as symptoms of a heart attack that include shortness of breath and a numb left arm, the classifier 205 recommends that the patient immediately go to a local hospital because the system 100 is not designed to accommodate true emergencies.

In one embodiment, the classifier 205 associates the patient with a classification based on whether the patient has an appointment. For example, in one embodiment, the classifier 205 associates a patient with an appointment with a first classification and a walk in patient with a second classification.

In one embodiment, the classifier 205 associates the patient with a classification based on the expected duration of consultation for the patient. The expected duration of the consultation may be determined based on one or more factors including, but not limited to, the patient's history (e.g. the patient has a history of longer than average consultations), the patient's condition (e.g. the average time for consulting a patient with the patient's condition), the ailment associated with the patient (e.g. average duration of a consultation by medical service providers associated with the specialty that matches the patient's ailment), etc.

In one embodiment, the classifier 205 passes the classification to the scheduler 209. For example, the classifier 205 is communicatively coupled to the scheduler 209 to send the classification to the scheduler 209. In another embodiment, the classifier 205 stores the classification in the storage device 241 (or any other non-transitory storage medium communicatively accessible). The other modules of the patient queuing module 107 including the scheduler 209 can retrieve the classification by accessing the storage device 241 (or other non-transitory storage medium). In yet another embodiment, the classifier 205 passes the classification to the EMR server 101 to update the patient's EMR in the EMR storage 103 and the other components of the patient queuing module 107 including the scheduler 209 can obtain the classification from the EMR storage 103. For example, the classifier 205 is communicatively coupled to the EMR server 101 to send the classification for storage in the EMR storage 103 and, in one embodiment, the scheduler 209 is communicatively coupled to obtain the classification therefrom.

The patient preference engine 207 is code and routines for determining one or more patient preferences. In one embodiment, the patient preference engine 207 is a set of instructions executable by the processor 235. In another embodiment, the patient preference engine 207 is stored in the memory 237 and is accessible and executable by the processor 235. In either embodiment, the patient preference engine 207 is adapted for cooperation and communication with the processor 235, other components of the web services server 105 and other components of the patient queuing module 107.

The patient preference engine 207 determines one or more preferences of the patient. In one embodiment, the one or more patient preferences of a patient are determined based at least in part on the patient's EMR. For example, in one embodiment, the patient preference engine 207 is communicatively coupled to the EMR server 101, obtains the patient's EMR and determines the patient's one or more preferences based at least in part on a medical history in the EMR.

In one embodiment, the one or more patient preferences of a patient are determined based at least in part on information from a node 109. For example, in one embodiment, the patient preference engine 207 is communicatively coupled to the node 109, obtains information regarding the patient at the node 109 (e.g. via a user interface displayed on the computing device 115a) and determines the patient's one or more preferences based at least in part on the information received from the node.

Depending on the embodiment, the one or more patient preferences may be explicit preferences, inferred preferences or a combination thereof. In one embodiment, the one or more patient preferences include an explicit preference. For example, assume the patient specifies that he/she would like to be consulted by a specific medical service provider (e.g. the patient made an appointment with the specific medical service provider or requested a specific medical service provider upon arrival at the node 109), in one embodiment, patient preference engine 207 determines that the patient prefers to be consulted by the medical service provider explicitly specified by the patient. Additional explicit preferences include, for example, a maximum wait time before the patient wants to see any medical service provider that is available. For example, the patient prefers to see a medical specialist but is only willing to wait 20 minutes for a specialist before the scheduler 209 should assign the next available medical service provider.

In another example, the patient preference engine 207 instructs the user interface engine 211 to generate a display to the patient after the consultation for rating the medical service provider. The patient preference engine 207 then tracks when the patient specifies (e.g. when the patient arrives at the node 109) that he/she would not like to be consulted by a medical service provider associated with a below average rating. In one embodiment, the patient preference engine 207 determines that the patient prefers to be consulted by a medical service provider with a rating at or below the rating explicitly specified by the patient.

In one embodiment, the one or more patient preferences include an inferred preference. For example, assume the patient previously consulted with Medical Service Provider A, in one embodiment, the patient preference engine 207 determines that patient prefers to be consulted by Medical Service Provider A. In another example, assume the patient is a female, in one embodiment, the patient preference engine 207 determines that patient prefers to be consulted by a medical service provider that is a female. In another example, assume that, in one embodiment, the web services server 105 includes a medical service provider review system (not shown). In one embodiment, the patient preference engine 207 infers that a patient would prefer to be treated by a medical service provider with positive reviews (e.g. is friendly, a good listener, thorough, takes the time to explain treatments options, etc.). In yet another example, assume that a medical service provider is explicitly preferred by many patients, in one embodiment, the patient preference engine 207 infers that a patient would prefer to be treated by that medical service provider because the medical service provider appears to be popular among patients. It will be recognized that the preceding are merely examples determining a patient preference based on an inferred preference and that other examples exist.

In one embodiment, the patient preference engine 207 passes the one or more patient preferences to the scheduler 209. For example, the patient preference engine 207 is communicatively coupled to the scheduler 209 to send the one or more patient preferences to the scheduler 209. In another embodiment, the patient preference engine 207 stores the one or more patient preferences in the storage device 241 (or any other non-transitory storage medium communicatively accessible). The other components of the patient queuing module 107 including the scheduler 209 can retrieve the one or more patient preferences by accessing the storage device 241 (or other non-transitory storage medium). In yet another embodiment, the patient preference engine 207 passes the one or more patient preferences to the EMR server 101 to update the patient's EMR in the EMR storage 103 and the other components of the patient queuing module 107 including the scheduler 209 can obtain the one or more patient preferences from the EMR storage 103. For example, the patient preference engine 207 is communicatively coupled to the EMR server 101 to send the one or more patient preferences for storage in the EMR storage 103 and, in one embodiment, the scheduler 209 is communicatively coupled to obtain the one or more patient preferences therefrom.

The scheduler 209 is code and routines for selecting a patient for remote, virtual consultation by a medical service provider. In one embodiment, the scheduler 209 is a set of instructions executable by the processor 235. In another embodiment, the scheduler 209 is stored in the memory 237 and is accessible and executable by the processor 235. In either embodiment, the scheduler 209 is adapted for cooperation and communication with the processor 235, other components of the web services server 105 and other components of the patient queuing module 107.

In one embodiment, the scheduler 209 is triggered when the scheduler 209 receives a notification from the authorization module 202 (via the processing unit 201) that a medical service provider with an authenticated token indicates availability. In one embodiment, an indication of availability is automatically sent. For example, assume an indication of availability is automatically sent when a medical service provider is logged in and not consulting a patient, in one embodiment, the scheduler 209 receives the indication of availability (e.g. from the hub 111 via the network 125 and processing unit 201) and schedules a patient for remote, virtual consultation with the medical service provider. In one embodiment, a software agent at the hub 111 polls the web services server 105 for patients (e.g. using HTTPS), and the scheduler 209 receives the poll as an indication of availability. In one embodiment, the nodes 109 (real or virtual) poll the scheduler for patients scheduled for a remote, virtual medical consultation. In one embodiment, the polling architecture eases security infrastructure requirements and beneficially allows the hub 111 to work behind network address translators (NATs).

The scheduler 209 generates a list of patients waiting for medical consultation. For example, when a patient at a node 109 provides a token that is authenticated by the authorization module 202, the scheduler 209 adds the patient to the list of patients waiting for medical consultation. In one embodiment, the list of patients includes information about each patient on the list. For example, the list of patients includes the patient's condition and the ailment associated with the patient.

In one embodiment, the scheduler 209 generates multiple lists of patients waiting for medical consultation. In one embodiment, the scheduler 209 generates multiple lists of patients waiting for medical consultation based on the node 109 associated with the patient. For example, assume the system 100 includes Node A and Node B. In one embodiment, the scheduler 209 generates a first list including the patients waiting for medical consultation at Node A and generates a second list for patients waiting at Node B. In one embodiment, the scheduler 209 generates multiple lists of patients waiting for medical consultation based on the ailment associated with the patient. For example, the scheduler 209 generates a first list of patients waiting to consult with a first medical service provider associated with a first specialty and generates a second list of patients waiting to consult with a second medical service provider associated with a second specialty.

In one embodiment, the list generated by the scheduler 209 is an ordered list of patients waiting for medical consultation. The order of the list of patients may be based on one or more criteria. Examples of criteria include, but are not limited to one or more of patient arrival time, the ailment associated with the patient, patient preferences, classification associated with the patient, etc. It will be recognized that the preceding are merely examples of criteria upon which the list of patients may be ordered and that other criteria exist.

The scheduler 209 selects patients from the list of patients waiting for medical consultation for remote, virtual consultation by a medical service provider. In one embodiment, selecting a patient for remote, virtual consultation by a medical service provider uses a combination of patient selection and node selection. For example, in one embodiment, the scheduler 209 selects a node 109, selects a patient waiting for medical consultation at that selected node and schedules the selected patient for remote, virtual consultation by a medical service provider. It will be recognized that the preceding is merely an example of scheduling a patient for remote, virtual consultation by a medical service provider using node selection and patient selection and that other examples exist.

The scheduler 209 selects a patient for remote, virtual consultation by a medical service provider from the list based on the ailment associated with the patient matching the specialty of the available medical service provider. For example, assume the patient is complaining of knee pain, the scheduler 209 does not select the patient if the available medical service provider is a dermatologist, but may select the patient if the available medical service provider is an orthopedist because an orthopedist may address knee pain. In one embodiment, the scheduler 209 selects a patient for remote, virtual consultation by a medical service provider from the list based on one or more additional factors. Examples of additional factors may include, but are not limited to, one or more of the patient's position in the list (if the list is an ordered list), patient arrival time, patient preferences, classification associated with the patient, etc. For example, assume all patients are associated with the same ailment, in one embodiment, a patient associated with an “urgent” classification has selection priority over a patient with an appointment, a patient with an appointment has selection priority over a walk-in patient (i.e. no appointment), and walk-in patients are prioritized for selection based on order of arrival and patient preferences. In another example, the scheduler 209 selects patients in the order the patients appear on the ordered list.

In one embodiment, the scheduler 209 allows a medical service provider to accept or reject the selected patient prior to assigning the medical service provider to consult the patient. For example, the scheduler 209 instructs the user interface engine 211 to generate graphical data for displaying the patient identifier (ID) and patient's condition to the medical service provider with an “accept” and “reject” option, and the scheduler 209 assigns the medical service provider to the patient based on the option selected. In one embodiment, responsive to the medical service provider accepting the selected patient, the scheduler 209 sends to the medical service provider the patient ID, an encounter ID, node information (e.g., the node 109) and a name of the server that handles the encounter (e.g., the EMR server 101 or the web services server 105). The scheduler 209 also transfers a provider ID that identifies the medical service provider, a name of the medical service provider (e.g., a doctor's name) and hub information (e.g., the hub 111) to the selected patient.

In one embodiment, the scheduler 209 communicates with the node 109, the hub 111, the EMR server 101 and other components of the patient queuing module 107 over hypertext transfer protocol secure (HTTPS). In one embodiment, the scheduler 209 uses standard HTTP messages including GET, POST, DELETE, etc., for communication between users at the node 109 or the hub 111. The users have received authorization tokens from the authorization module 202 for accessing scheduler services. For example, the scheduler 209 uses a POST message to add an authorized patient to a queue that includes a list of patients waiting for medical consultation and uses a DELETE message to remove an authorized patient from the queue. In another example, once a medical service provider accepting a selected patient, the scheduler 209 uses GET messages to allow the medical service provider at the hub 111 and the selected patient at the node 109 to exchange each other's information.

In one embodiment, the scheduler 209 performs node selection to determine the node 109 from which a patient should be selected for remote, virtual consultation by a medical service provider. In one embodiment, node selection is based on whether a consultation device is available at the node 109. For example, assume Node A's consultation device is in use, in one embodiment, the scheduler 209 does not select Node A, and, therefore, the scheduler 209 does not select a patient from Node A for virtual, remote consultation.

In one embodiment, the scheduler 209 performs node selection using one or more of a round robin selection, node load factor based selection and a weighted combination of round robin and node load factor based selection. Node selection using a round robin technique may enhance fairness perceived by the patient at a node 109. Node selection that is a function of the node load factor may maintain an equal queue length across nodes 109 (which may consequently cause similar anticipated wait times across nodes). A weighted combination of round robin selection and node load factor selection may balance the orthogonal interests of perceived fairness and equal queue length.

In a system with multiple hubs 111 and nodes 109 it may be difficult to enforce a strict round robin and/or node load-factor selection, because the time required for a remote consultation session is random and non-deterministic (e.g. modeled as exponential service rates) and the patient arrival rates are random (e.g. modeled using different Poisson arrival rates at each node). However, the scheduler ensures that over a period of time the probability distribution function of nodes being serviced is a uniform distribution for round robin/a curve based on the load factor at each node for preferential node selection. In other words for a setup with nodes (N) with patients (Pᵢ) at each node (i), the scheduler statistically guarantees an eventual node-selection probability of 1/N for round robin selection, Pᵢ/ΣPᵢ for node load factor selection and [w*(1/N)]+[(1−w)*Pᵢ/ΣPᵢ] for the weighted combination of round robin and node load factor selection, where “w” is an administrator configurable value that lies between zero (pure node load factor selection) and 1 (pure round robin selection).

In one embodiment, the scheduler 209 does not use node selection in certain situations. In one embodiment, the scheduler 209 does not use node selection when the list includes a patient associated with the urgent classification. This beneficially ensures that a patient having a medical emergency is rapidly selected by the scheduler 209 for medical consultation without regard to the node 109 associated with that patient. In one embodiment, the scheduler 209 does not use node selection when the list includes a patient associated with a current appointment. This beneficially ensures that a patient that has an appointment is selected by the scheduler 209 for medical consultation at, or near, the appointment time and without regard to the node 111 associated with that patient. In another embodiment, the scheduler 209 does not use node selection for store and forward situations. In still another embodiment, the scheduler 209 does not use node selection for referral consultations. In yet another embodiment, the scheduler 209 does not use node selection when the scheduler has applied a reservation.

In one embodiment, store and forward comprises a virtual node, which has lower priority than physical nodes. For example, selection of a store and forward from a virtual node occurs only when no patients are currently waiting at a physical node.

A referral consultation is a consultation that occurs between a patient and a medical service provider that is a general practitioner. In one such embodiment, a referral consultation is a consultation that occurs between a patient and a medical service provider that is a general practitioner which requires further consultation by a specialist. For example, assume that a patient arrives at a node 109 complaining of knee pain and is subsequently scheduled for remote, virtual consultation with a general practitioner. Also assume that all consultations are digitally recorded and stored with the patient's EMR and that the general practitioner eliminates the possibility of arthritis and based on the consultation believes the patient may have damaged a ligament. In one embodiment, the stored consultation between the patient and general practitioner is forwarded to an orthopedist to confirm or reject the general practitioner's diagnosis. In another example, assume the patient arrives at the node 109 for a follow-up consultation regarding side effects of a cancer treatment regime prescribed by an oncologist, but an oncologist is not available. In one embodiment, a general practitioner is assigned to consult with the patient and the consultation is recorded, stored and then forwarded to an oncologist for review when an oncologist becomes available (e.g. the next time an oncologist logs into the system 100). Referral and store and forward both consultations beneficially ensure that a patient's ailment is reviewed by a medical service provider with a specific specialty without requiring the patient to be available at the same time as the specialist.

In one embodiment, the referral consultation comprises a virtual node, which receives priority over the physical nodes. For example, node selection of physical nodes occurs only when no patient associated with a referral consultation is associated with the available medical service provider. In another embodiment, the referral consultations comprise a virtual node, which have lower priority than physical nodes. For example, selection of a referral consultation from a virtual node occurs only when no patients are currently waiting at a physical node.

In one embodiment, a reservation overrides one or more of the scheduler's 209 normal patient selection and node selection. Depending on the embodiment and circumstances (e.g. node selection method, patient arrival and consultation rates), a particular patient may wait for a very long time. For example, a patient may be the first walk-in patient to arrive at a node to see a medical service provider associated with a given specialty, but several walk-in patients at the node may consult with a medical service provider associated with the given specialty while the first walk-in patient waits (e.g. because of patient selection criteria). In another embodiment, where there are multiple consultation devices and multiple medical service providers, a medical service provider associated with a given specialty may not be available at the same time that the consultation device is available. As a result, other patients occupy the consultation device before the first patient because the consultation device and the medical service provider with the proper specialty are not both available at the same time. In one embodiment, the scheduler 209 analyzes the list of patients waiting for medical consultation and determines the time period each patient has been waiting. When the scheduler 209 determines that the time period exceeds a threshold, the scheduler 209 applies a reservation.

Depending on the embodiment, the time period may include one or more of an elapsed time (e.g. hours) and a number of times skipped (N). In one embodiment, the time period is configurable by an administrator. For example, assume an administrator has set a reservation to be applied if a patient is waiting for more than one hour or if three other patients associated with the same ailment as the patient and who arrived after the patient are consulted while the patient is waiting (i.e. the threshold is 1 hour and N=3). In one embodiment, the scheduler 209 applies a reservation when one of those thresholds is met or exceeded.

In one embodiment, the reservation overrides the scheduler's 209 normal patient selection and node selection. For example, in one embodiment, the scheduler 209 reserves a consultation device for the patient at the node 109 of the patient associated with the reservation, assigns the next available medical service provider associated with the specialty that matches the ailment associated with the patient and that (depending on the embodiment) satisfies the patient's preferences to consult with the patient. In another example, the scheduler 209 reserves a consultation device for the patient at the node 109 of the patient associated with the reservation, so that the node 109 will not be busy and skipped during normal node selection when a medical service provider associated with the specialty that matches the ailment associated with the patient is available. In one embodiment, a patient with an urgent classification overrides a reservation. For example, assume a reservation is applied so that a first patient will be the next to consult with a medical service provider associated with specialty X, and a second patient is registered and is experiencing an urgent condition, in one embodiment, the reservation is overridden and the second patient is scheduled for medical consultation before the first patient.

In one embodiment, the scheduler 209 passes the patient selection to the node 109 associated with the selected patient and the hub 111 associated with the assigned medical service provider. For example, the scheduler 209 is communicatively coupled to the node 109 associated with the selected patient and the hub 111 associated with the assigned medical service provider to send the patient selection to the node 109 associated with the selected patient and the hub 111 associated with the assigned medical service provider. In another embodiment, the scheduler 209 stores the patient selection in the storage device 241 (or any other non-transitory storage medium communicatively accessible). The other components of the system 100 including the node 109 associated with the selected patient and the hub 111 associated with the assigned medical service provider can retrieve the patient selection by accessing the storage device 241 (or other non-transitory storage medium).

The user interface engine 211 is code and routines for generating graphical data for displaying user interface data for scheduling a patient for remote, virtual consultation by a medical service provider. In one embodiment, the user interface engine 211 is a set of instructions executable by the processor 235. In another embodiment, the user interface engine 211 is stored in the memory 237 and is accessible and executable by the processor 235. In either embodiment, the user interface engine 211 is adapted for cooperation and communication with the processor 235, other components of the web services server 105 and other components of the system 100.

The user interface engine 211 generates graphical data for displaying a user interface for scheduling a patient for remote, virtual consultation by a medical service provider. In one embodiment, at least a portion of the data and information used by the patient queuing module 107 and its components is received via a user interface. For example, assume node personnel use the computing device 115a to check boxes associated with symptoms in a user interface and to enter vital statistics into the user interface, and the medical analyzer 203 receives patient medical information based on the check boxes and vital statistics entered into the user interface. In one embodiment, the user interface engine 211 generates user interface data for that user interface.

### User Interfaces

FIG. 3 illustrates an example of a user interface 300 according to one embodiment. User interface 300 is an example of patient data which, in one embodiment, is filled out by node personnel and stored in the EMR storage 103 as part of the patient's EMR. In the illustrated embodiment, the patient data includes medical information about the patient including the patient's gender, date of birth (DOB), the patient's chronic conditions, previous vital statistics, lab results, reason for visit, an ailment associated with the patient, the patient's primary care physician, patient preferences, appointments and the urgency of medical consultation. In one embodiment, one or more of the ailments associated with the patient, the patient's primary care physician, patient preferences, appointments and the urgency of medical consultation are used by the scheduler 209 when scheduling the patient for remote, virtual medical consultation.

### Methods

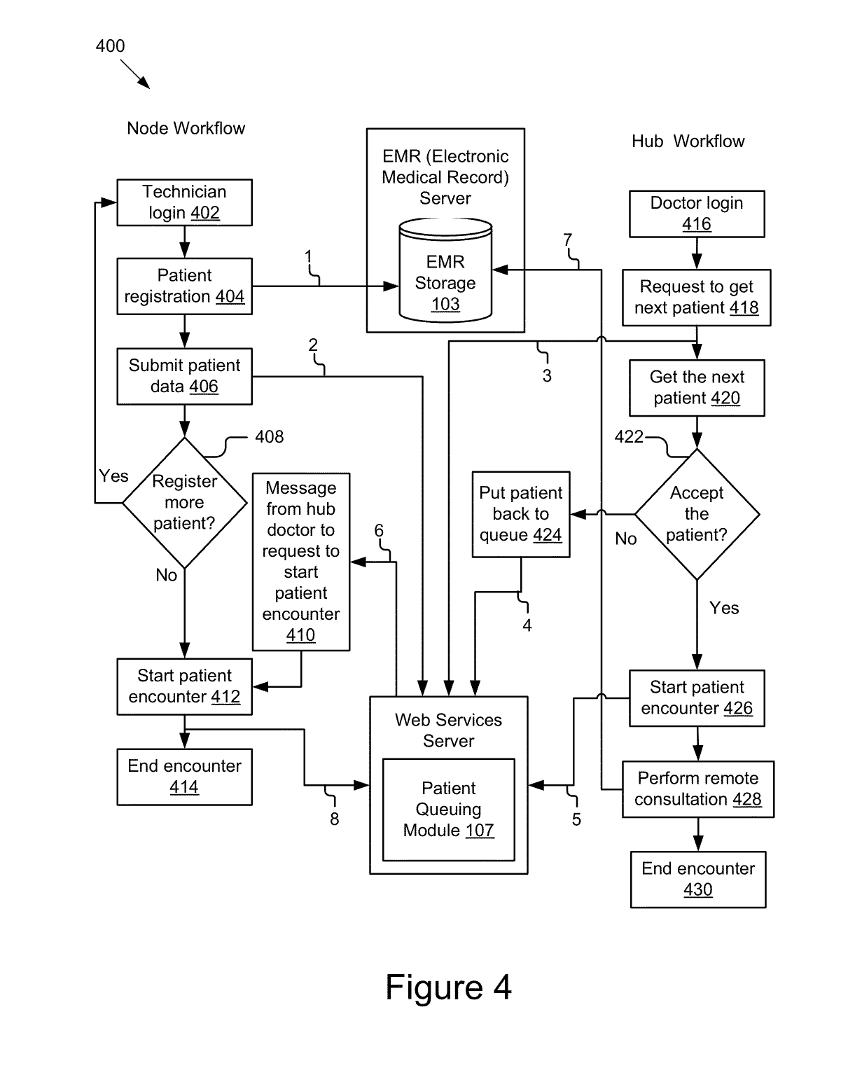

FIGS. 4, 5 and 6 depict various methods 400, 500, 600 performed by the system described above with reference to FIGS. 1, 2A and 2B. FIG. 4 is a workflow diagram illustrating a method 400 for scheduling a patient for remote, virtual consultation by a first available matching medical service provider according to one embodiment. In this example, the portion of the processing unit 201 that performs user registration resides at the node 109. Persons of ordinary skill in the art will recognize that the processing unit 201 could also be stored at the web services server 105 and displayed at the node 109.

The workflow at the node 109 begins at block 402. At block 402, the authentication module 202 receives and allows a technician to log-in (i.e. activate) the node 109 by issuing a token to the technician and authenticating the token during log-in. At block 404, the authentication module 202 registers the patient and transmits the registration information to the EMR server 101 for storing in the EMR storage 103 as illustrated by line 1. The registration information is input either by the technician or the patient. At block 406, patient data is submitted by the processing unit 201 to the patient queuing module 107 of the web services server 105 for scheduling as illustrated by line 2. At block 408, a determination is made whether to register another patient. If a determination is made to register another patient (412—Yes), the method continues at block 402 and blocks 402-408 are repeated. If a determination is made not to register another patient (412—No), the method continues at block 412 (after receiving, at block 410, a request to start a patient encounter from the patient queuing module 107 as illustrated by line 6). The determination is influenced, for example, by the number of available nodes 109.

At block 412, a patient encounter starts. At block 414, the patient encounter ends and the patient queuing module 107 is signaled that the encounter has ended as illustrated by line 8. In one embodiment, the workflow of the node 109 is performed at least in part on or by a computing device 115a.

The workflow at the hub 111 begins at block 416. At block 402, the processing unit 201 allows a doctor to log-in (i.e. register) at the hub 111. At block 418, the processing unit 201 receives a doctor's request for the next patient, which is sent to the patient queuing module 107 as illustrated by line 3. At step 420, selection of the next patient is obtained from the scheduler 209. At step 422, a determination is made about whether the doctor accepts the next patient obtained at step 420. If the doctor rejects the next patient (422—No), at block 424, a request to return the patient to the queue is sent to the patient queuing module 107 as illustrated by line 4. If the doctor accepts the next patient (422—Yes), a request to start a patient encounter is sent to the patient queuing module 107, as illustrated by line 5, and the request to start a patient encounter is sent from the patient queuing module 107 to the node 109, as illustrated by line 6, and, at block 426, a patient encounter starts. At block 428, the doctor performs the remote, consultation and the patient's EMR is updated by the processing unit 201, as illustrated by line 7, based on the consultation. At block 430, the encounter ends.

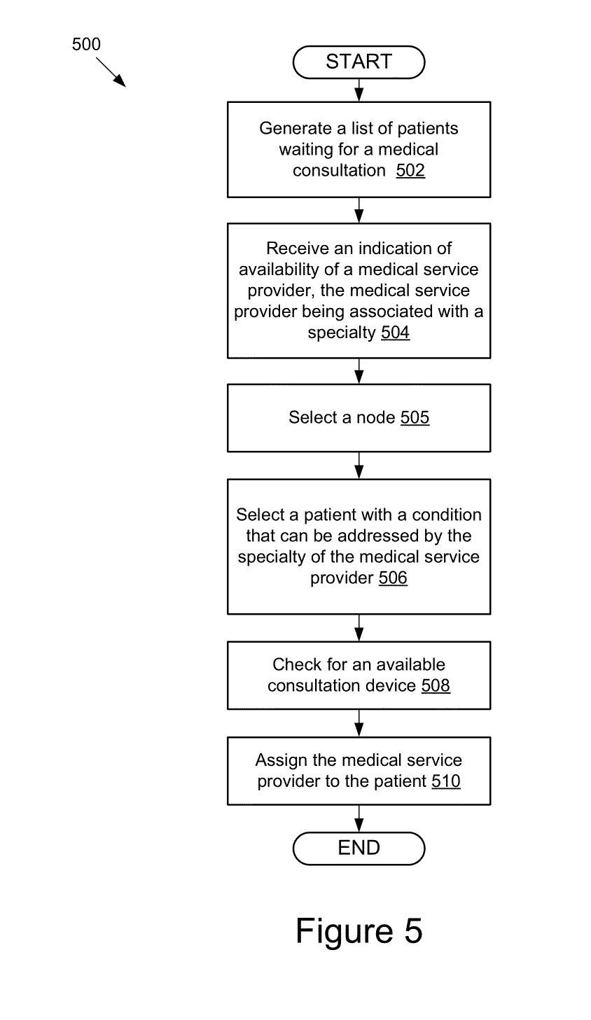

FIG. 5 is a flow chart illustrating a general method 500 for scheduling a patient for remote, virtual consultation by a first available matching medical service provider according to one embodiment. At block 502, the scheduler 209 of the patient queuing module 107 generates a list of patients waiting for medical consultation. Each patient in the list has received an authorization token from the authorization module 202 to access scheduler services. At block 504, the scheduler 209 receives an indication of availability from a medical service provider, the medical service provider being associated with a specialty. At block 505, the scheduler 209 selects a node. For example, the scheduler 209 selects a node 109 based on a weighted combination of round robin and node load factors. At block 506, the scheduler 209 selects a patient with a condition that can be addressed by the specialty associated with the medical service provider. At block 508, the scheduler checks for an available consultation device at the node 109 associated with the patient. At block 510, the scheduler assigns the medical service provider to the patient for medical consultation and the method 500 ends.

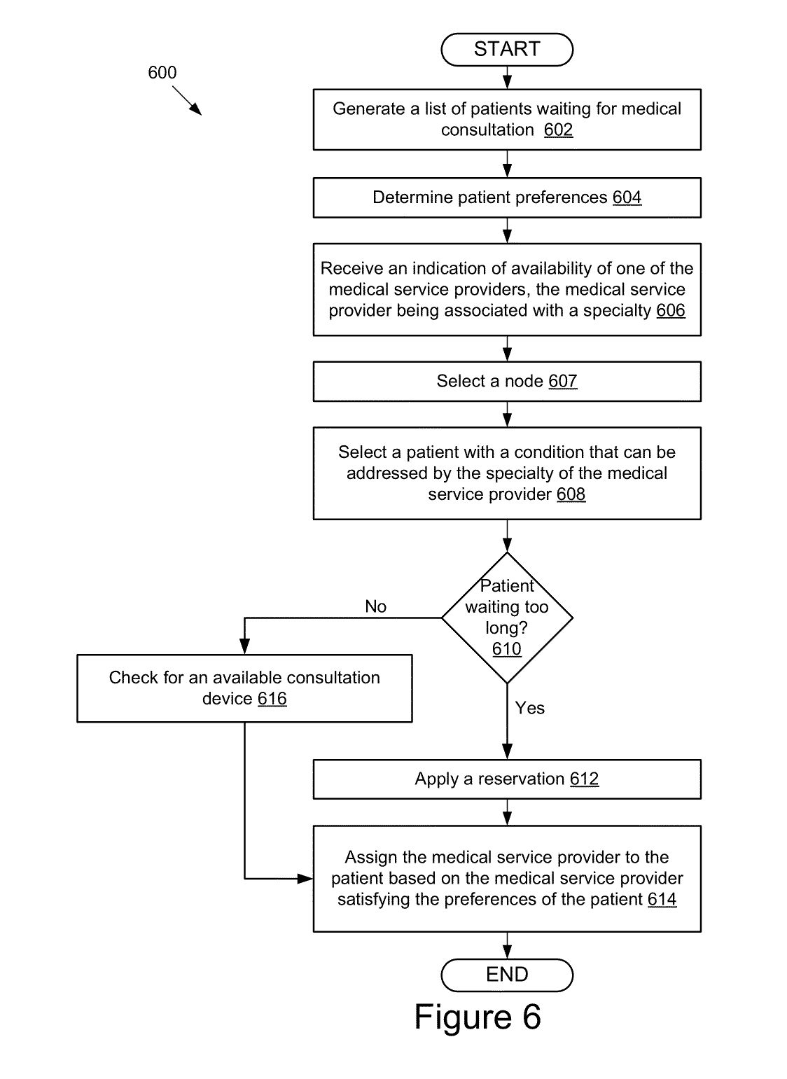

FIG. 6 is a flow chart illustrating a more detailed method 600 for scheduling a patient for remote, virtual consultation by a first available matching medical service provider according to one embodiment. At block 602, the scheduler 209 of the patient queuing module 107 generates a list of patients waiting for medical consultation. Each patient in the list has received an authorization token from the authorization module 202 to access scheduler services. At block 604, the patient preference engine 207 determines patient preferences of the patients waiting for medical consultation. At block 606, the scheduler 209 receives an indication of availability from a medical service provider, the medical service provider being associated with a specialty. At block 607, the scheduler 209 selects a node 109. For example, the scheduler 209 selects a node 109 based on a weighted combination of round robin and node load factors. At block 608, the scheduler 209 selects a patient with a condition that can be addressed by the specialty associated with the medical service provider. At block 610, the scheduler 209 determines whether a patient has been waiting too long. If the scheduler 209 determines that a patient has been waiting too long (610—Yes), the scheduler 209 applies a reservation at block 612 and, at block 614, assigns the medical service provider to the patient based on the medical service provider satisfying the preferences of the patient. If the scheduler 209 determines that a patient has not been waiting too long (610—No), the scheduler 209 checks for an available consultation device at block 612 and, at block 614, assigns the medical service provider to the patient based on the medical service provider satisfying the preferences of the patient.

### Simulations of Scheduling

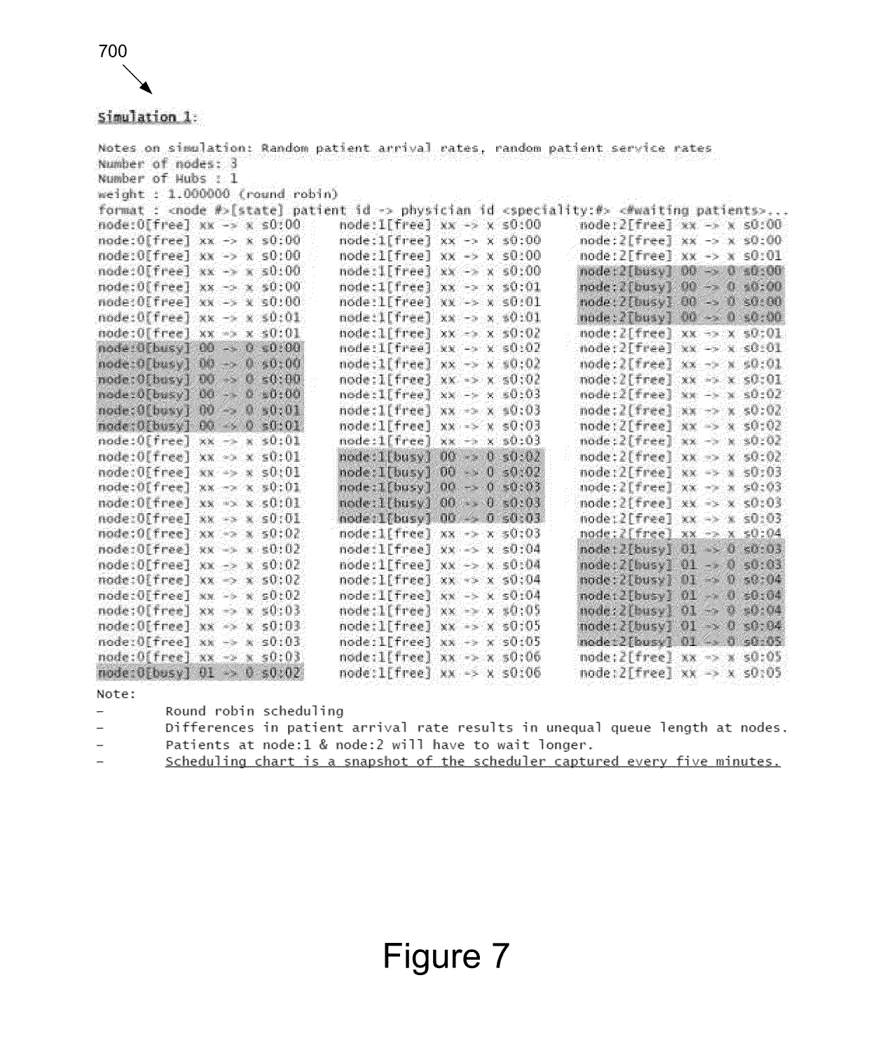

FIGS. 7-11 depict simulations 700, 800, 900, 1000 and 1100 of scheduling a patient for remote, virtual consultation by a medical service provider according to various embodiments. For purposes of clarity and convenience the simulations 700, 800, 900, 1000 and 1100 are based on systems 100 with three nodes (Node 0, Node 1 and Node 2). Columns include entries for a single node 109 (e.g. the first column is Node 0 entries, the second column is Node 1 entries, etc.) and each row of entries corresponds to a time, e.g., a five minute time interval separates each row. Each entry in the simulation has a format. The format includes the node number, the node's current state, patient ID, physician ID, a specialty number, and the number of patients waiting. An example of an entry is “node:1[busy] 08->0 s0:03 s1:02” which shows that at the time corresponding to the entry (i.e. the row) node 1 was being used (i.e. “busy”) by patient “08” of node 1 to consult with medical service provider “0” and that three patients are waiting to consult with a medical service provider associated with specialty “0” and two patients are waiting to consult with a medical service provider associated with specialty “1.” It will be recognized that the simulations 700, 800, 900, 1000 and 1100 are merely examples of the scheduler 209 scheduling a patient for remote, virtual consultation by a medical service provider and that other simulations exist (e.g. using different formats) and that other system configurations exist (e.g. having different numbers of nodes 109 and hubs 111).

Referring to FIG. 7, a simulation 700 scheduling a patient for remote, virtual consultation by a medical service provider using round robin node selection is illustrated according to one embodiment. The simulation 700 simulates a system with one hub 111. The one hub is associated with a medical service provider associated with physician id “0” who is associated with a specialty capable of addressing conditions of patients waiting to consult a medical service provider associated with specialty number “0” (e.g. medical service provider “0” is associated with the specialty associated with specialty number “0”). The round robin node selection loops through the nodes 109 in an order.

In the illustrated simulation 700, the scheduler 209 selects nodes by round robin in the order Node 0, Node 1, Node 2 and then repeats the order. For example, in the first two rows of the simulation, there are no patients at any of the three nodes. At the third row, the scheduler 209 loops through the nodes in order. Node 0 has no patients, so Node 0 is skipped. Node 1 has no patients, so Node 1 is also skipped. Node 2 has a patient waiting to see a medical service provider associated with specialty “0” as indicated by the “s0:01” portion of the entry. The scheduler 209 schedules the waiting patient (patient “00”) for a remote medical consultation with the medical service provider and, beginning at row 4, the consultation occurs. The consultation is indicated by the “busy” state and has been shaded for clarity and convenience. When the medical service provider “0” has finished consulting with patient “00” of Node 2, the scheduler 209 receives an indication of medical service provider “0's” availability and, using round robin selection, selects the next node in the ordered loop, which is Node 0. Node 0 has a patient with a condition that can be addressed by the medical service provider (i.e. s0:01), so the patient (patient “00” of Node 0) is scheduled for medical consultation. When the medical service provider “0” has finished consulting with patient “00” of Node 0, the scheduler 209 receives an indication of medical service provider “0's” availability and, using round robin selection, selects the next node in the ordered loop, which is Node 1. Node 1 has two patients waiting, so the scheduler selects a patient (patient “00” of Node 1) to schedule for medical consultation and so on. A round robin scheduler may enhance fairness perceived by the patient at a node 109.

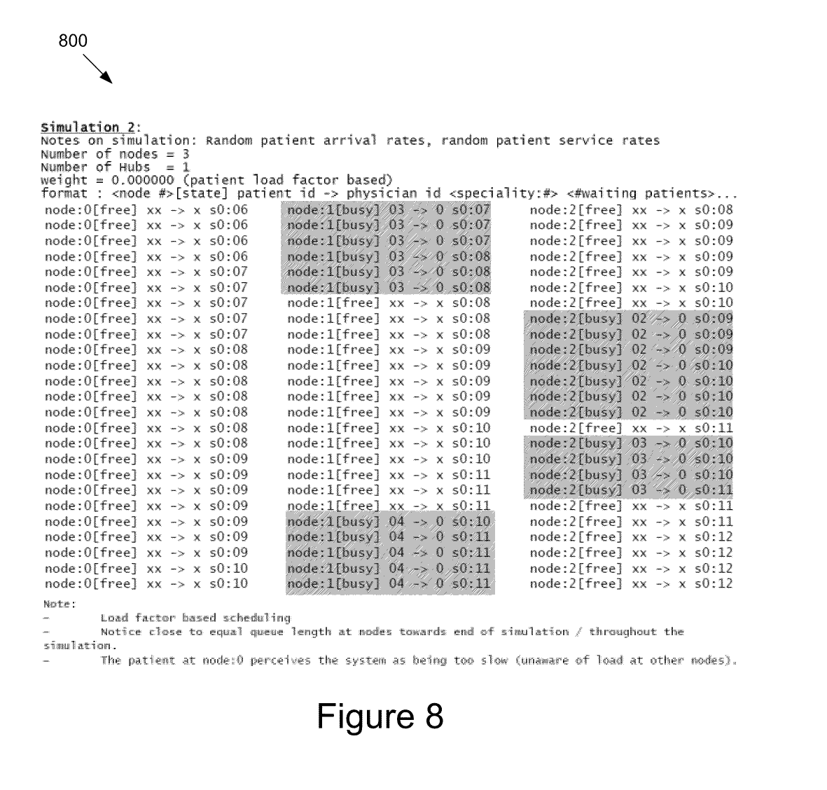

Referring to FIG. 8, a simulation 800 scheduling a patient for remote, virtual consultation by a medical service provider using node load factor selection is illustrated according to one embodiment. The simulation 800 simulates a system with one hub 111. The one hub is associated with a medical service provider associated with physician id “0” who is associated with a specialty capable of addressing conditions of patients waiting to consult a medical service provider associated with specialty number “0” (e.g. medical service provider “0” is associated with the specialty associated with specialty number “0”).

In the illustrated simulation 800, the scheduler 209 selects nodes using node load factor selection. Node load factor selection tries to maintain an equal number of patients waiting for medical consultation at each node. For example, referring to the first shaded block in the right column, patient “02” of Node 2 is scheduled by the scheduler 209 using node load factor selection because, at the time, Node 2 had 10 patients waiting while Node 0 had only 7 patients waiting, and Node 1 had only 8 patients waiting. Patient “03” of Node 2 is subsequently scheduled by the scheduler 209 using node load factor selection because, at the time, Node 2 had 11 patients waiting while Node 0 had only 8 patients waiting, and Node 1 had only 10 patients waiting.

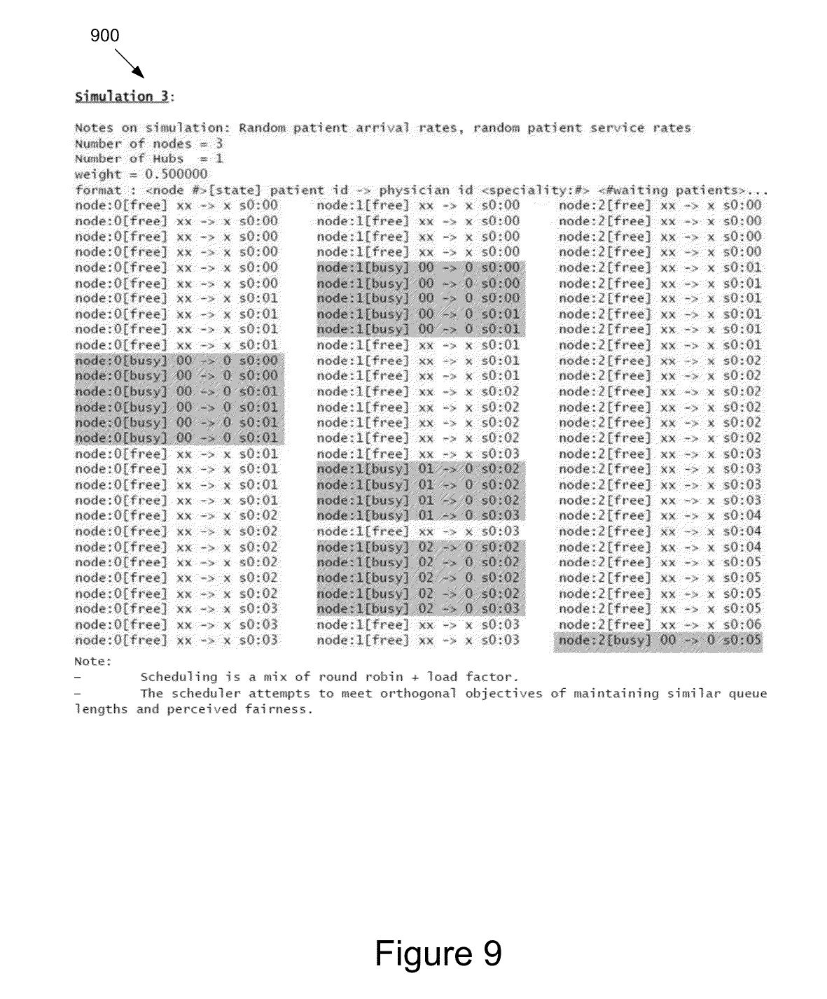

Referring to FIG. 9, a simulation 900 scheduling a patient for remote, virtual consultation by a medical service provider using an equally weighted combination of round robin and load factor based node selection is illustrated according to one embodiment. The simulation 900 simulates a system with one hub 111. The one hub is associated with a medical service provider associated with physician id “0” who is associated with a specialty capable of addressing conditions of patients waiting to consult a medical service provider associated with specialty number “0” (e.g. medical service provider “0” is associated with the specialty associated with specialty number “0”).

In the illustrated simulation 900, the scheduler selects nodes using an equally weighted combination of round robin and node load factor selection. Node selection using the weighted combination of round robin and node load factor selection may balance the orthogonal objectives of maintaining similar numbers of patients waiting at each node and the perceived fairness.

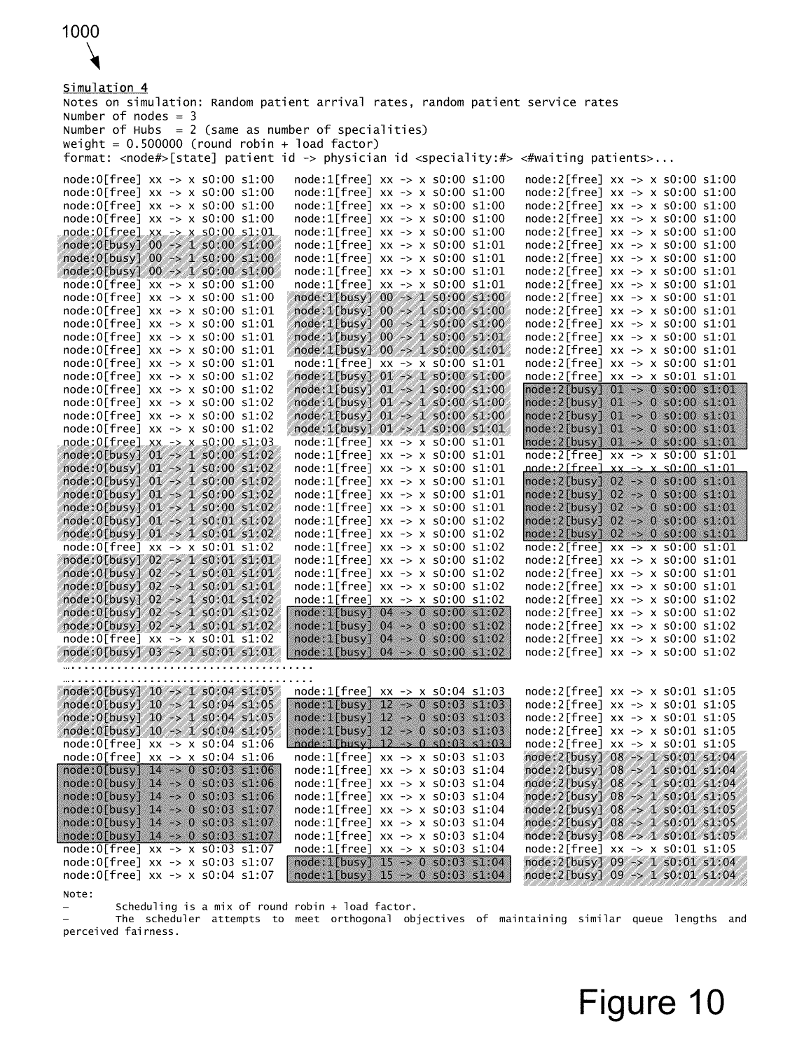

Referring to FIG. 10, a simulation 1000 scheduling a patient for remote, virtual consultation by a medical service provider using a combination of round robin and load factor based node selection is illustrated according to one embodiment. The simulation 1000 simulates a system with two hubs 111. Each of the two hubs 111 is associated with a medical service provider. One hub 111 is associated with a medical service provider with physician identifier “0” who is associated with a specialty capable of addressing conditions of patients waiting to consult a medical service provider associated with specialty number “0” (e.g. medical service provider “0” is associated with the specialty associated with specialty number “0”). The other hub 111 is associated with a medical service provider with physician identifier “1” who is associated with a specialty capable of addressing conditions of patients waiting to consult a medical service provider associated with specialty number “1” (e.g. medical service provider “1” is associated with the specialty associated with specialty number “1”).

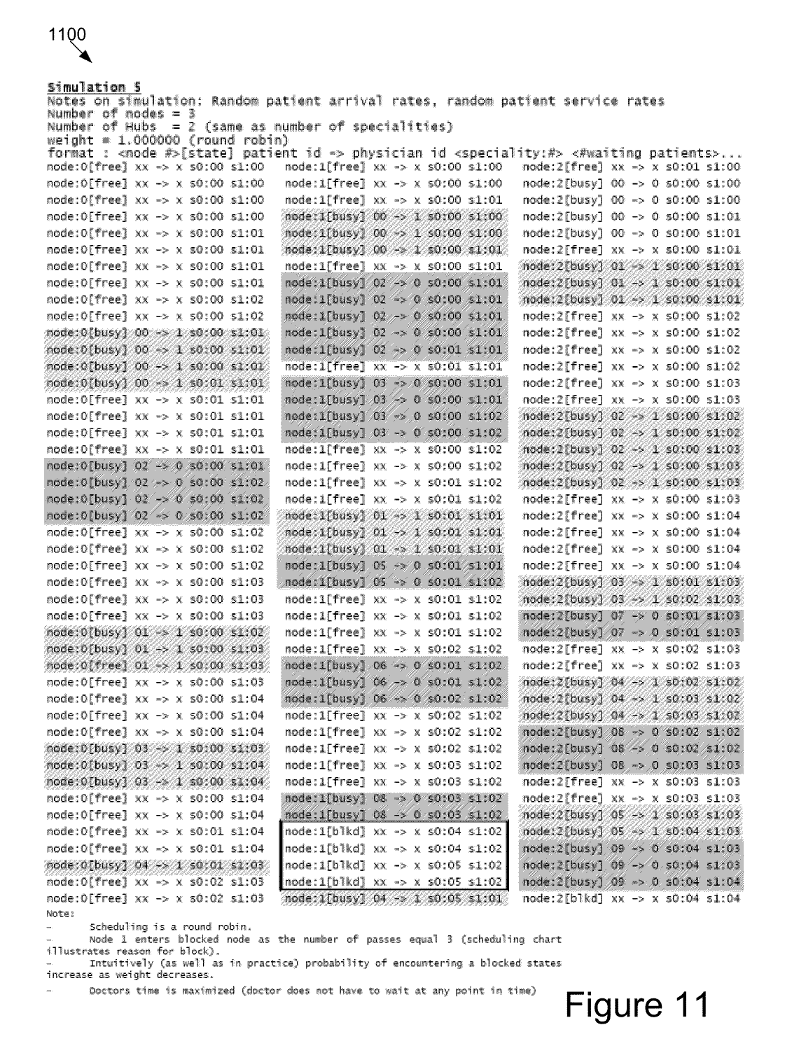

Referring to FIG. 11, a simulation 1100 scheduling a patient for remote, virtual consultation by a medical service provider using round robin selection is illustrated according to one embodiment. The simulation 1100 simulates a system with two hubs 111. Each of the two hubs 111 is associated with a medical service provider. One hub 111 is associated with a medical service provider with physician id “0” who is associated with a specialty capable of addressing conditions of patients waiting to consult a medical service provider associated with specialty number “0” (e.g. medical service provider “0” is associated with the specialty associated with specialty number “0”). The other hub 111 is associated with a medical service provider with physician id “1” who is associated with a specialty capable of addressing conditions of patients waiting to consult a medical service provider associated with specialty number “1” (e.g. medical service provider “1” is associated with the specialty associated with specialty number “1”).

In the illustrated simulation 1100, the scheduler selects nodes using round robin selection. Referring to the first shaded region in the first column, the scheduler 209 scheduled patient “00” of Node 0 to consult with medical service provider “1.” When medical service provider “1” has finished consulting with patient “00” of Node 0, the scheduler 209 checks to see if there's a patient associated with an ailment type that matches specialty “1” and whether a consultation device is available at Node 1 (i.e., the next node in the round robin order). Node 1 is busy because it is being used by patient “03” of Node 1 to consult with medical service provider “0.” Therefore, the scheduler 209 skips Node 1 although Node 1 has a patient waiting to see a medical service provider with the specialty of medical service provider “1.” The scheduler 209 checks Node 2 to see if there's a patient associated with an ailment type that matches specialty “1” and whether a consultation device is available at Node 2. Since Node 2 is available and has two patients associated with an ailment type that matches specialty “1,” the scheduler 209 schedules one of the patients (patient “02” of Node 2) for consultation by medical service provider “1.”

FIG. 11 illustrates an example of a reservation. The reservation is boxed with a border for clarity and convenience in FIG. 11. In one embodiment, a reservation is applied when a patient's wait time has exceeded a threshold. In one embodiment, a reservation is applied when a patient has been skipped a specific number of times (e.g. when 3 patients who arrived at after a first patient at the same node as the patient have received a medical consultation while the first patient has been waiting). For example, assume that patient numbering and patient selection are performed in order of arrival in simulation 1100 and that a reservation is applied when a patient is skipped 3 times. In illustrated embodiment, patient “04” of Node 1 has been skipped, while waiting for a medical service provider associated with specialty “1,” by three patients that arrived after him/her (i.e. patients “05,” “06” and “08” of Node 1). Therefore, the scheduler 209 applies a reservation to Node 1 ensuring that Node 1 is available for use by patient “04” of Node 1 when medical service provider “1” becomes available. When service provider “1” becomes available, patient “04” of Node 1 is scheduled for consultation with medical service provider “1.” In one embodiment, even if Node 1 was not the next node in the round robin for medical service provider “1,” the reservation over-rides the round robin order and schedules patient “04” of Node 1 as medical service provider “l's” next consultation.

### Pseudo Code

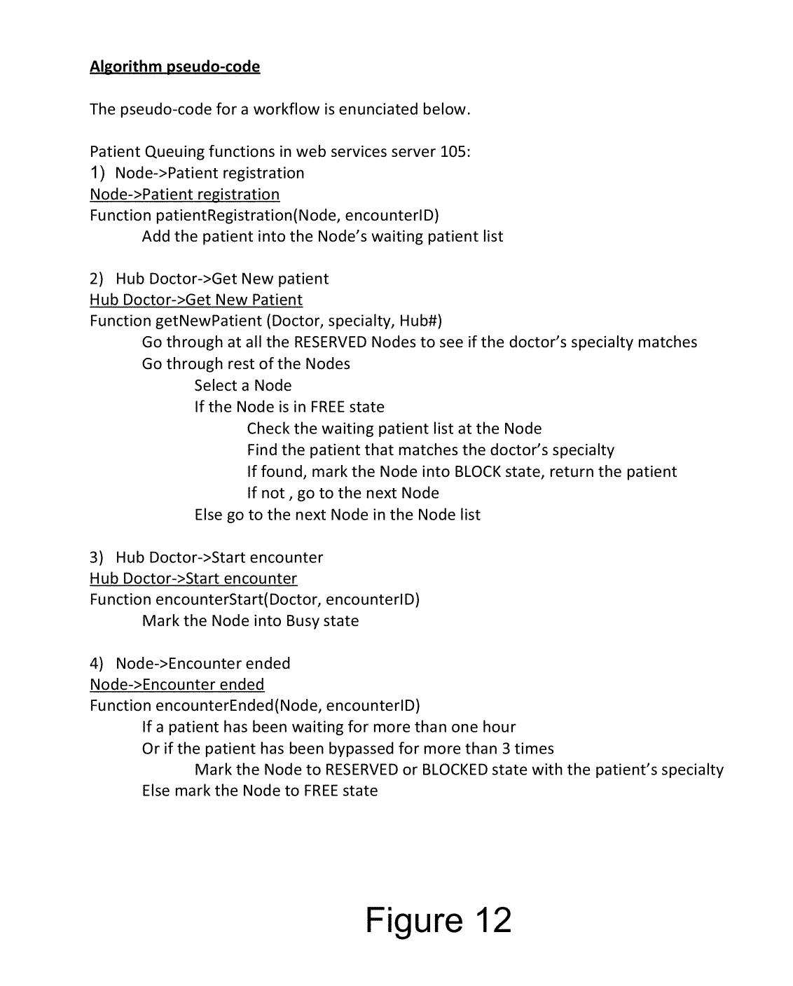

FIG. 12 is an illustration of algorithm pseudo-code for scheduling a patient for remote, virtual consultation by a first available matching medical service provider according to one embodiment. Specifically, FIG. 12 is an illustration of pseudo-code for the patient queuing module 107 of the webs services server 105. In one embodiment, the processing unit 201 performs patient registration. In one embodiment, the scheduler 209 selects a patient for remote, virtual consultation by a first available matching medical service provider (i.e. gets a new patient), and the medical service provider consults with the patient. In one embodiment, when the consultation begins, the scheduler 209 marks the node as busy, which affects node selection. In one embodiment, when the consultation ends, the scheduler 209 analyzes the patient waiting list for that node and determines whether to apply a reservation. If the scheduler 209 determines to apply a reservation to a node associated with the patient, the node is changed from “FREE” to “RESERVED” or “BLOCKED.”

The foregoing description of the embodiments has been presented for the purposes of illustration and description. It is not intended to be exhaustive or to limit the present embodiments to the precise forms disclosed. Many modifications and variations are possible in light of the above teaching. It is intended that the scope of the present embodiments be limited not by this detailed description, but rather by the claims of this application. As will be understood by those familiar with the art, the present embodiments may take other specific forms without departing from the spirit or essential characteristics thereof. Likewise, the particular naming and division of the modules, routines, features, attributes, methodologies and other aspects are not mandatory or significant, and the mechanisms that implement one embodiment or its features may have different names, divisions and/or formats. Furthermore, as will be apparent, the modules, routines, features, attributes, methodologies and other aspects of the embodiments can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the embodiments are in no way limited to implementation in any specific programming language, or for any specific operating system or environment. Accordingly, the disclosure is intended to be illustrative, but not limiting, of the scope, which is set forth in the following claims.

What is claimed is:

1. A method for scheduling a patient for remote, virtual consultation by a first available matching medical service provider, the method comprising:
generating, using one or more computing devices, a list of patients waiting for a medical consultation;
receiving, using the one or more computing devices, an indication of availability of the first medical service provider, the first medical service provider associated with a specialty;
responsive to receiving the indication of availability of the first medical provider, selecting, using the one or more computing devices, a patient from the list of patients based at least in part on the patient having an ailment that can be addressed by the specialty associated with the first medical service provider;
checking, using the one or more computing devices, for an available consultation device at a node associated with the patient; and
responsive to the consultation device being available to the patient at the node, assigning, using the one or more computing devices, the first medical service provider for remote, virtual consultation with the patient.

2. The method of claim 1 further comprising:
determining, using the one or more computing devices, one or more preferences of the patient, and
wherein at least one of selecting the patient and assigning the first medical service provider for remote, virtual consultation with the patient is based at least in part on the one or more preferences of the patient.

3. The method of claim 1 further comprising:
determining, using the one or more computing devices, a time period the patient has been on the list of patients waiting for the medical consultation; and
responsive to the time period exceeding a threshold, applying a reservation to the consultation device at the node associated with the patient, the reservation reserving the availability of the consultation device for the patient.

4. The method of claim 1 further comprising:
determining, using the one or more computing devices, a time period the patient has been on the list of patients waiting for the medical consultation; and
responsive to the period exceeding a threshold, applying a reservation to the first medical service provider, wherein the reservation associated with the patient matches the specialty associated with the first medical service provider.

5. The method of claim 1, wherein the list of patients is an ordered list, the order based at least in part on one or more of arrival time of the patients, ailment, patient appointment time and urgency of medical attention.

6. The method of claim 1, further comprising determining the ailment of the patient based on information received from medical devices at the node.

7. The method of claim 1, wherein the first medical service provider is a general practitioner and further comprising:
capturing and storing, using the one or more computing devices, virtual consultation data; and
responsive to instructions from the first medical service provider, forwarding, using the one or more computing devices, a pointer to the virtual consultation data to a second medical service provider associated with the specialty that matches the ailment associated with the patient.

8. A system for scheduling a patient for remote, virtual consultation by a first available matching medical service provider, the system comprising:
a classifier operable to associate a specialty with the first medical service provider;
a medical analyzer operable to identify an ailment associated with the patient and identify a specialty of medical service provider that can address the ailment; and
a scheduler operable to (1) generate a list of patients waiting for medical consultation, (2) receive an indication of availability of the first medical service provider, (3) responsive to receiving the indication of availability of the first medical provider, select a patient from the list of patients based at least in part on whether the first medical service provider is associated with the specialty of medical service provider that can address the ailment associated with the patient, (4) check for an available consultation device at a node associated with the patient, and (5) responsive to the consultation device being available to the patient at the node, assign the first medical service provider for remote, virtual consultation with the patient, the scheduler communicatively coupled to the classifier to obtain the specialty associated with the first medical service provider and communicatively coupled to the medical analyzer to obtain the specialty of medical service provider that can address the ailment.

9. The system of claim 8 further comprising:
a patient preference engine operable to determine one or more preferences of the patient; and
wherein the scheduler is further operable to perform one or more of the selecting of the patient and the assigning of the first medical service provider for remote, virtual consultation with the patient based at least in part on the one or more preferences of the patient, the scheduler communicatively coupled to the patient preference engine to obtain the one or more preferences of the patient.

10. The system of claim 8, wherein the scheduler is further operable to determine a time period the patient has been on the list of patients waiting for the medical consultation, and responsive to the time period exceeding a threshold, apply a reservation to the consultation device at the node associated with the patient, the reservation reserving the availability of the consultation device for the patient.

11. The system of claim 8, wherein the scheduler is further operable to determine a time period the patient has been on the list of patients waiting for the medical consultation, and responsive to the time period exceeding a threshold, apply a reservation to the first medical service provider, wherein the ailment associated with the patient matches the specialty associated with the first medical service provider.

12. The system of claim 8, wherein the list of patients is an ordered list, the order based at least in part on one or more of arrival time of the patients, ailment, patient appointment time and urgency of medical attention.

13. The system of claim 8, the medical analyzer is further operable to determine the ailment of the patient based on information received from medical devices at the node, the medical analyzer communicatively coupled to receive information from the medical devices at the node.

14. The system of claim 8, wherein the first medical service provider is a general practitioner and the system further comprising:
a storage device operable to store virtual consultation data, the storage device communicatively coupled to the consultation device to receive the virtual consultation data; and
the scheduler further operable to receive instructions from the first medical provider, and responsive to the instructions from the first medical service provider, forward a pointer to the virtual consultation data to a second medical service provider associated with the specialty that matches the ailment associated with the patient.

15. A computer program product comprising a computer useable medium including a computer readable program, wherein the computer readable program when executed on a computer causes the computer to:
generate a list of patients waiting for a medical consultation;
receive an indication of availability of the first medical service provider, the first medical service provider associated with a specialty;
responsive to receiving the indication of availability of the first medical provider, select a patient from the list of patients based at least in part on the patient having a ailment that can be addressed by the specialty associated with the first medical service provider;
check for an available consultation device at a node associated with the patient; and
responsive to the consultation device being available to the patient at the node, assign the first medical service provider for remote, virtual consultation with the patient.

16. The computer program product of claim 15, further causing the computer to:
determine one or more preferences of the patient, and
wherein at least one of the selection of the patient and assignment of the first medical service provider for remote, virtual consultation with the patient is based at least in part on the one or more preferences of the patient.

17. The computer program product of claim 15, further causing the computer to:
determine a time period the patient has been on the list of patients waiting for the medical consultation; and
responsive to the time period exceeding a threshold, apply a reservation to the consultation device at the node associated with the patient, the reservation reserving the availability of the consultation device for the patient.

18. The computer program product of claim 15, further causing the computer to:
determine a time period the patient has been on the list of patients waiting for the medical consultation;
responsive to the period exceeding a threshold, apply a reservation to the first medical service provider, wherein the ailment associated with the patient matches the specialty associated with the first medical service provider.

19. The computer program product of claim 15, further causing the computer to determine the ailment of the patient based on information received from medical devices at the node.

20. The computer program product of claim 15, further causing the computer to:
storing, using the one or more computing devices, virtual consultation data; and
responsive to instructions from the first medical service provider, wherein the first medical service provider is a general practitioner, forwarding, using the one or more computing devices, a pointer to the virtual consultation data to a second medical service provider associated with the specialty that matches the ailment associated with the patient.
